(19) United States
(12) Patent Application Publication
(10) Pub. No.: US 2023/0070236 A1
(43) Pub. Date: Mar. 9, 2023

(54) METHOD AND COMPOSITION FOR IMPROVED HYDRATION IN ANIMALS

(71) Applicants: Alon ROSENBERG, Rehovot (IL); KALMARNA LIMITED, (US)

(72) Inventors: Alon ROSENBERG, Rehovot (IL); Abraham MILSTEIN, Rehovot (IL); Ava Marie FIRTH, West Bridgford, Nottinghamshire (GB); Simon VAN DALSEM, Alkmaar (NL); Arie HALPERN, Pully (CH)

(73) Assignee: Alon ROSENBERG, Rehovot (IL)

(21) Appl. No.: 17/977,034

(22) Filed: Oct. 31, 2022

Related U.S. Application Data
(63) Continuation-in-part of application No. 16/865,697, filed on May 4, 2020, now abandoned.
Application No. 16/865,697 is a continuation-in-part of application No. PCT/IL2019/050472, filed on Apr. 29, 2019.

(51) Int. Cl. A23K 20/142; A23K 20/163; A23K 20/22; A23K 50/40; A23K 50/20; A23K 40/10

(52) U.S. Cl. CPC A23K 20/142; A23K 20/163; A23K 20/22; A23K 50/40; A23K 50/20; A23K 40/10

(57) ABSTRACT

The present invention discloses oral isotonic compositions to provide hydration to mammals in need, comprising a prebiotic oligosaccharide or fructo-oligosaccharide and at least three members of the group consisting of steviol glycoside, citric acid monohydrate, glutamic acid, monosodium glutamate and glycine.

### CROSS REFERENCE TO RELATED APPLICATIONS

This application is a Continuation-in-Part of U.S. patent application Ser. No. 16/865,697, filed May 4, 2020, which is a Continuation-in-Part of PCT International Application No. PCT/IL2019/050471, filed Apr. 29, 2019, which claims priority from U.S. Provisional Patent Application Nos. 62/664,174 filed on Apr. 29, 2018, and 62/723,496, filed on Aug. 28, 2018. All of these prior applications are hereby incorporated by reference in their entirety.

### FIELD OF THE INVENTION

This invention relates to a method and composition for increasing hydration in animals.

### BACKGROUND OF THE INVENTION

Physical activity in hot environments can increase the risk of heat stress or heat stroke in pets. Pets, or companion animals, are affected by high temperatures and humidity; heat tolerance is thus influenced by acclimatization to the environment, physical fitness, and hydration state.

Since dogs have minimal sweating capacity, thermoregulation relies primarily on evaporative mechanisms through panting. Given dogs' inability to sweat (except through the pads of their feet), dogs rely on panting to cool them down and high temperatures, coupled with a lack of water, can severely interfere with this process, leading to dehydration. High humidity can also negatively affect a canine's capacity for evaporative cooling. Even in moderate temperatures, dogs can even suffer from dehydration; see Sodhi, Nidhi. “Dog hydration strategies.” Aust Vet J 2018; 96(3):N20 (2018), incorporated herein as a reference.

In addition to the environmental factors of heat and humidity, the dog's adaptation to environmental conditions (acclimatization), overall fitness/conditioning and state of hydration are thought to be major factors that impact heat tolerance. Canine thermoregulation involves the inhalation of cooler, dryer air through the nose and mouth, which causes evaporative heat loss from the nasal and oral mucosa and tongue, and the exhalation of hotter, moister air. In conditions in which the rate of heat generation is greater than the rate of heat dissipation, increased salivation and lingual blood flow allow for convection and evaporative cooling). Evaporative cooling results in electrolyte-free water loss (estimated at ˜10 mL/kg/h) which can contribute to dehydration, see Otto, Cynthia M., et al. “evaluation of three hydration strategies in Detection Dogs Working in a hot environment.” Frontiers in veterinary science 4 (2017), incorporated herein as a reference.

Dogs primarily cool themselves through panting, rather than sweating through skin surfaces. The only areas of skin that a dog uses for sweating are its nose and footpads. Panting necessarily involves the exhalation of warm air from the lungs. This air is also moist, and therefore panting may result in considerable water losses from the dog. Dogs may become measurably dehydrated after only 15 minutes of exercise, losing an average of 0.83% of their body weight and showing visually detectable changes in skin turgor (Goucher T. Amer. J. Vet. Research 2019 80(2): 123-8, incorporated herein as a reference). Panting is an inefficient method of cooling however, and dogs may become hyperthermic after only a short period of exercise. This was demonstrated in the study by Zanghi, in which dogs had an increase in core body temperatures of 2.5-3° C. after only 30 minutes of exercise in moderate environmental temperatures (Zanghi et al., Front. Vet. Sci. 2018, 5:202, incorporated herein as a reference). This is a dangerous rise in body temperature. In the study by Evans, heat stroke was the most common cause of medical (non-behavioral) discharge in military working dogs less than 5 years old, accounting for 8.2% of the discharges (Evans R. I., J. Amer. Vet. Med. Assoc, 2007, 231(8):1215-20, incorporated herein as a reference). Studies show that well-hydrated dogs are less prone to dehydration following physical activity (Baker et al., J. Physiol. Pharmacol. 1991, 42(3):305-316, incorporated herein as a reference). Oral rehydration solutions have also been shown to be more effective than either plain water or subcutaneous fluids in minimizing markers of dehydration such as increased creatinine, increased hematocrit, increased total plasma protein and decreased total CO₂ (Otto, C. M., Front. Vet. Sci. 2013 4 (October) 174, incorporated herein as a reference).

Dehydration in horses is a major concern for those involved in the equine industry, especially during the hot summer months. At these times high temperatures can induce increased sweating rates in horses, potentially causing water and electrolyte losses to reach dangerous levels, see Green, B. L., and J. L. Wahrmund. “143 Impact of Hydration Supplements on Blood Electrolyte Concentrations of Exercised Horses. During the Summer.” Journal of Animal Science94.suppl_1 (2016): 69-70., incorporated herein as a reference.

The domestic cat is adapted to retain water by producing urine which is very concentrated compared to most other mammals. Producing highly concentrated urine, however, can have deleterious effects, such as enhancing development of urinary stones and other less well-defined urinary tract conditions such feline idiopathic cystitis. Manipulating hydration is the most appealing approach to prevent dehydration and increase heat tolerance and workability. Prior documents disclose methods and hydration strategies for pets: Palatability enhancers for pet food are known in the art. U.S. Pat. Nos. 6,354,920 and 6,350,485 to Brunner, incorporated herein as a reference, disclose the use of tetrasodium pyrophosphate as a palatability enhancer for dry and semi-moist cat food. U.S. Pat. No. 5,186,964 to Gierhart et al. discloses the use of a pyrophosphate salt or an acid phosphate salt as a palatability enhancer for dry pet food. U.S. Pat. No. 7,244,460 to Lee et al. discloses the use of a tripolyphosphate salt as a palatability enhancer for dry and semi-dry pet food. The use of a palatability enhancer as a flavoured drinking water additive is discloses in US patent application 20140127352 to Woodward et al. US patent application 20140127352 to Woodward et al discloses flavoured drinking water additives and flavoured drinking water compositions, as well as methods for increasing water consumption by an animal and improving hydration for animals using the flavoured drinking water additives and flavoured drinking water compositions of Woodward et al.'s invention based on pyrophosphate salts. US patent application 20180085309 to Baskins incorporated herein as a reference discloses a pet hydration System, comprising of specific ranges of vitamins and minerals conducive to a pet's health, with such nutrients placed into a liquid beverage and ultimately dispensed via a compartmentalized beverage dispenser. The compartmentalized beverage dispenser is formed such that separate liquids are measured out and dispensed to the pet in a manner that the pet receives the optimal amount of nutrition. US patent application US20170172180 to Znaghi discloses composition and methods for improving hydration and water intake in an animal. In one embodiment, a hydration composition can comprise water and a hydration additive, where the hydration additive consists essentially of a sugar alcohol and a protein, where the sugar alcohol includes glycerol and the protein includes whey. Additionally, a method of improving hydration and water intake in an animal can comprise administering the hydration composition with water to the animal. U.S. Pat. No. 9,884,035B2 to Brockman et al., discloses methods and compositions for improving the level of hydration in a cat. Cats fed diets containing certain amounts and ratios of arachidonic acid and eicosapentaenoic acid will be sufficiently hydrated and at reduced risk for development of urinary stones, feline idiopathic cystitis.

Cats commonly experience complications of dehydration also, but it is more of a chronic problem. Cats are notoriously fussy drinkers and this fact is recognized by the International Cat Care Association and World Small Animal Veterinary Association (https://icatcare.org/advice/how-guides/how-encourage-your-cat-drink).

Because of these habits, domestic cats are quite susceptible to chronic dehydration which results in the production of highly concentrated urine. Chronic dehydration may lead to renal disease, which is a common cause of illness in cats. Producing highly concentrated urine, in turn, can have further deleterious effects, such as lower urinary tract disease (LUTD), which is also common in cats. There is evidence that increasing fluid intake and urine dilution may reduce the recurrence of LUTD (Grant, D. J. Feline Med. Surg. 2010 12(6): 431-4, incorporated herein as a reference).

Mink have been farmed for fur in the United States for 130 years. In 2010, the U.S. ranked fifth in production behind Denmark, China, the Netherlands, and Poland. Mink typically breed in March and give birth to their litters in May. (see Wikipedia, “fur faming”, incorporated herein as a reference).

Mortality in mink kits held under conventional farm conditions is believed to be related to dehydration, see Brink, A-L., Leif Lau Jeppesen, and Knud Erik Heller. “Behaviour in suckling mink kits under farm conditions: effects of accessibility of drinking water.” Applied Animal Behaviour Science 89.1 (2004): 131-137; incorporated herein as a reference.

Maintaining adequate hydration levels is vital for health in animals. However, ensuring adequate water intake in some companion animals, particularly cats and dogs, can be quite challenging in some situations. Lack of adequate water intake can lead to dehydration, heat stroke and renal/urinary disease.

Thus, increasing water intake, is a major factor in reducing or preventing dehydration in companion animals. However, dogs and cats are not easily enticed to increase their water intake. In order to increase drinking in cats and dogs, palatants and flavorings have been added to drinking water provided to pets. WO 2009/009879 to Ramsey et al, discloses a beverage composition for promoting hydration in animals, comprising water, an attractant having a flavor and odor reminiscent of meat and a biologically active enzyme or plant extract. US 2011/02668664 to Martinez et al, discloses and effervescent composition for increasing water intake in animals, comprising an effervescent agent, and a meat, fish or dairy based palatant. An additional composition for increasing water intake in animals is disclosed by Zanghi, in US 2017/0172180. The composition comprises water, glycerol and whey protein. US 2008/009879 to Gaggioti, discloses a drink for animals based on water containing meat or meat extracts, vegetable extracts, minerals and vitamins.

As shown above, physical activity is known to increase an individual's water requirement, particularly while exercising. Additionally, stress related to travel, boarding, or illness also compromises hydration status in cats, minks and dogs and horses. Thus, there remains a need for compositions and methods to improve water intake and increase hydration in companion animals such as dogs, cats and horses.

Chlorinous flavours at the food and drinks are the leading cause of human and animals' complaints, dissatisfaction and dehydration, see e.g., Piriou, Philippe, et al. “Chlorinous flavour perception in drinking water.” Water Science and Technology 49.9 (2004): 321-328. A chlorine-free taste in foods and drinks are hence a long-felt need.

### SUMMARY OF THE INVENTION

It is one object of the invention to disclose an oral isotonic composition characterized by no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an oral isotonic composition characterized by no residual chlorine taste for the hydration of mammals comprising (a) at least three members of the group consisting of steviol glycoside, citric acid monohydrate, monosodium glutamate, glycine, mixtures and derivatives thereof and (b) prebiotic any derivatives and mixtures thereof.

It is another object of the invention to disclose an oral composition for providing hydration to a mammal, said formulation in the form of a dry mix comprising glycine and at least two components selected from the group consisting of steviol glycoside, citric acid monohydrate, glutamic acid, and monosodium glutamate, wherein said dry mix is characterized by a glycine concentration of 5-6% (w/w). In some preferred embodiments of the invention, said oral composition is in the form of an aqueous solution of said dry mix, said aqueous solution characterized by a glycine concentration of 0.001-0.2% (w/v). In some especially preferred embodiments of the invention, said aqueous solution is characterized by a glycine concentration selected from the group consisting of 0.15% and 0.17% (w/v).

In some embodiments of the invention, said aqueous solution comprises a 0.1-7% (w/v) solution of the dry mix (0.1-7 g dry mix/100 g solution). In some embodiments, the aqueous composition comprises an aqueous solution of the dry mix in which the dry mix concentration is selected from the group consisting of (percentages w/v) about 0.1%; about 0.2%; about 3%; about 5%; and about 7%.

Prebiotics are food ingredients that induce the growth or activity of beneficial microorganisms (e.g., bacteria and fungi). The term ‘prebiotic’ hence refers hereinafter, in a non-limiting manner, to prebiotics derived from both endogenous and exogenous sources, and to at least one member of the group consisting of edibles being non-digestible and resistant to breakdown by stomach acid and enzymes in the human gastrointestinal tract; edibles selectively fermented by intestinal microorganisms; and edibles that selectively target and stimulate the growth and activity of beneficial bacteria; see Hutkins R W et al., (2016). “Prebiotics: why definitions matter”. Curr Opin Biotechnol. 37: 1-7. The term also refers to synbiotics, e.g., food ingredients or dietary supplements combining probiotics and prebiotics in a form of synergism, see DeVrese M, Schrezenmeir J (2008) Probiotics, prebiotics, and synbiotics in food biotechnology (pp. 1-66). Springer Berlin Heidelberg which is incorporated herein as a reference.

It is another object of the invention to disclose an isotonic drink characterized by no residual chlorine taste for the hydration of mammals comprising at least three members of the group consisting of steviol glycoside, citric acid monohydrate, monosodium glutamate, glycine, mixtures and derivatives thereof; and any derivatives and mixtures thereof.

It is another object of the invention to disclose an isotonic drink composition characterized by no residual chlorine taste for the hydration of mammals comprising (a) at least three members of a group consisting of steviol glycoside, citric acid monohydrate, monosodium glutamate, glycine, mixtures and derivatives thereof; and (b) prebiotic any derivatives and mixtures thereof.

It is another object of the invention to disclose an apple flavoured horses' isotonic drink characterized by no residual chlorine taste comprising (a) at least three members of a group consisting steviol glycoside, citric acid monohydrate, monosodium glutamate, glycine, mixtures and derivatives thereof; and (b) an apple-flavouring agent.

The term ‘apple-flavouring agent’ refers herein after, inter alia and in a non-limiting manner, to one or more of the following: apple extracts, apple flavour No. 64625, malic acids, esters, salts and derivatives thereof, apple flavour fragrance, e.g., as defined in CN patent applications 107279615, 104830607 and 105212170, JP patent application 2011152095, Maxarome AC 1632, all are incorporated herein as references, taste enhancers, emulsifiers and stabilizers thereof.

Maxarome AC 1632 is a concentrated, high performance flavour developed specifically for inclusion into animal feeds where it will improve palatability and encourage feed intake. Maxarome AC 1632 includes Vanillin and other aldehydes, together with mixed esters. Maxarome AC 1632 has the following characteristics: Physical Appearance: Beige-pale brown free flowing powder; Volatile Matter: 38.94%; Solubility: Insoluble; Bulk Density: 0.625 g/cm³; Flavour Classification: Nature Identical; Flavour Type: Spicy Apple; Product Classification: Conforms to EU Regulation 1831/2003—Annex 1, 2(b); Pre-mixture of flavouring compounds; Added Colouring: None Added; Antioxidants: None Added.

It is another object of the invention to disclose an apple flavoured horses' isotonic drink characterized by no residual chlorine taste comprising (a) at least three members of a group consisting steviol glycoside, citric acid monohydrate, monosodium glutamate, glycine, mixtures and derivatives thereof; (b) An apple-flavouring agent; and (c) prebiotic.

It is another object of the invention to disclose an isotonic taste enhancer, e.g., fluid, solid or gel-formed taste enhancer, edible meal topper, a treat tec., characterized by no residual chlorine taste for the hydration of mammals comprising at least three members of a group consisting steviol glycoside, citric acid monohydrate, monosodium glutamate, glycine, mixtures and derivatives thereof.

It is another object of the invention to disclose an isotonic taste enhancer characterized by no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

It is another object of the invention to disclose an isotonic taste enhancer characterized by no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an isotonic taste enhancer composition characterized by no residual chlorine taste for the hydration of mammals comprising (a) at least three members of a group consisting steviol glycoside, citric acid monohydrate, monosodium glutamate, glycine, mixtures and derivatives thereof and (b) prebiotic.

It is another object of the invention to disclose an isotonic apple flavoured horses' taste enhancer characterized by no residual chlorine taste comprising (a) at least three members of a group consisting steviol glycoside, citric acid monohydrate, monosodium glutamate, glycine, mixtures and derivatives thereof; and (b) an apple-flavouring agent.

It is another object of the invention to disclose an isotonic Apple flavoured horses' taste enhancer characterized by no residual chlorine taste comprising (a) at least three members of a group consisting steviol glycoside, citric acid monohydrate, monosodium glutamate, glycine, mixtures and derivatives thereof; (b) an apple-flavouring agent; and (c) prebiotic.

It is another object of the invention to disclose an edible powder characterized by no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an edible powder characterized by no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

It is another object of the invention to disclose an edible powder characterized by no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an edible powder composition characterized by no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

It is another object of the invention to disclose an apple flavoured horses' edible powder characterized by no residual chlorine taste comprising (a) at least three members of a group consisting steviol glycoside, citric acid monohydrate, monosodium glutamate, glycine, mixtures and derivatives thereof; and (b) an apple-flavouring agent.

It is another object of the invention to disclose an apple flavoured horses' edible powder characterized by no residual chlorine taste comprising (a) at least three members of a group consisting steviol glycoside, citric acid monohydrate, monosodium glutamate, glycine, mixtures and derivatives thereof; (b) An apple-flavouring agent; and (c) prebiotic.

It is another object of the invention to disclose an edible gel characterized by no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an edible gel composition characterized by no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

It is another object of the invention to disclose an edible isotonic gel characterized by no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an edible isotonic gel composition characterized by no residual chlorine taste for the hydration of mammals comprising (a) at least three members of a group consisting steviol glycoside, citric acid monohydrate, monosodium glutamate, glycine, mixtures and derivatives thereof and (b) prebiotic any derivatives and mixtures thereof.

It is another object of the invention to disclose an apple flavoured horses' edible isotonic gel characterized by no residual chlorine taste comprising (a) at least three members of a group consisting steviol glycoside, citric acid monohydrate, monosodium glutamate, glycine, mixtures and derivatives thereof; and (b) an apple-flavouring agent.

It is another object of the invention to disclose an apple flavoured horses' edible isotonic gel characterized by no residual chlorine taste comprising (a) at least three members of a group consisting steviol glycoside, citric acid monohydrate, monosodium glutamate, glycine, mixtures and derivatives thereof; (b) an apple-flavouring agent; and (c) prebiotic.

It is another object of the invention to disclose a solid shear thinning thixotropic edible gel characterized by no residual chlorine taste for the hydration of mammals comprising at least three members of the group consisting of steviol glycoside, citric acid monohydrate, monosodium glutamate, glycine, mixtures and derivatives thereof.

It is another object of the invention to disclose a solid shear thinning thixotropic edible gel characterized by no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

It is another object of the invention to disclose an apple flavoured horses' solid shear thinning thixotropic edible gel characterized by no residual chlorine taste comprising (a) at least three members of a group consisting steviol glycoside, citric acid monohydrate, monosodium glutamate, glycine, mixtures and derivatives thereof; and (b) an apple-flavouring agent.

It is another object of the invention to disclose an apple flavoured horses' solid shear thinning thixotropic edible gel characterized by no residual chlorine taste comprising (a) at least three members of a group consisting steviol glycoside, citric acid monohydrate, monosodium glutamate, glycine, mixtures and derivatives thereof; (b) an apple-flavouring agent; and (c) prebiotic.

It is another object of the invention to disclose an oral isotonic composition characterized by no residual chlorine taste for the hydration of mammals comprising (a) a member of the group consisting of vaccines, iron-containing compositions, minerals, salts, amino acids, medicaments, vitamins, nutraceuticals, antibiotics and food supplements; and (b) at least three members of the group consisting of steviol glycoside, citric acid monohydrate, monosodium glutamate, glycine, mixtures and derivatives thereof.

It is another object of the invention to disclose an oral isotonic composition characterized by no residual chlorine taste for the hydration of mammals comprising (a) a member of the group consisting of vaccines, iron-containing compositions, minerals, salts, amino acids, medicaments, vitamins, nutraceuticals, antibiotics and food supplements; (b) at least three members of a group consisting steviol glycoside, citric acid monohydrate, monosodium glutamate, glycine, mixtures and derivatives thereof and (c) prebiotic any derivatives and mixtures thereof.

It is another object of the invention to disclose an isotonic drink characterized by no residual chlorine taste for the hydration of mammals comprising (a) a member of the group consisting of vaccines, iron-containing compositions, minerals, salts, amino acids, medicaments, vitamins, nutraceuticals, antibiotics and food supplements; and (b) at least three members of the group consisting of steviol glycoside, citric acid monohydrate, monosodium glutamate, glycine, mixtures and derivatives thereof; and any derivatives and mixtures thereof.

It is another object of the invention to disclose an isotonic drink composition characterized by no residual chlorine taste for the hydration of mammals comprising (a) a member of the group consisting of vaccines, iron-containing compositions, minerals, salts, amino acids, medicaments, vitamins, nutraceuticals, antibiotics and food supplements; and (b) at least three members of a group consisting steviol glycoside, citric acid monohydrate, monosodium glutamate, glycine, mixtures and derivatives thereof; and (c) prebiotic any derivatives and mixtures thereof.

It is another object of the invention to disclose an apple flavoured horses' isotonic drink characterized by no residual chlorine taste comprising (a) a member of the group consisting of vaccines, iron-containing compositions, minerals, salts, amino acids, medicaments, vitamins, nutraceuticals, antibiotics and food supplements; (b) at least three members of the group consisting of steviol glycoside, citric acid monohydrate, monosodium glutamate, glycine, mixtures and derivatives thereof; and (c) an apple-flavouring agent.

It is another object of the invention to disclose an apple flavoured horses' isotonic drink characterized by no residual chlorine taste comprising (a) a member of the group consisting of vaccines, iron-containing compositions, minerals, salts, amino acids, medicaments, vitamins, nutraceuticals, antibiotics and food supplements; (b) at least three members of the group consisting of steviol glycoside, citric acid monohydrate, monosodium glutamate, glycine, mixtures and derivatives thereof; (c) An apple-flavouring agent; and (d) prebiotic.

It is another object of the invention to disclose an edible powder characterized by no residual chlorine taste for the hydration of mammals comprising (a) a member of the group consisting of vaccines, iron-containing compositions, minerals, salts, amino acids, medicaments, vitamins, nutraceuticals, antibiotics and food supplements; and (b) at least three members of the group consisting of steviol glycoside, citric acid monohydrate, monosodium glutamate, glycine, mixtures and derivatives thereof.

It is another object of the invention to disclose an edible powder characterized by no residual chlorine taste for the hydration of mammals comprising (a) a member of the group consisting of vaccines, iron-containing compositions, minerals, salts, amino acids, medicaments, vitamins, nutraceuticals, antibiotics and food supplements; (b) at least three members of the group consisting of steviol glycoside, citric acid monohydrate, monosodium glutamate, glycine, mixtures and derivatives thereof and (c) prebiotic any derivatives and mixtures thereof.

It is another object of the invention to disclose an edible powder characterized by no residual chlorine taste for the hydration of mammals comprising (a) a member of the group consisting of vaccines, iron-containing compositions, minerals, salts, amino acids, medicaments, vitamins, nutraceuticals, antibiotics and food supplements; (b) at least three members of the group consisting of steviol glycoside, citric acid monohydrate, monosodium glutamate, glycine, mixtures and derivatives thereof.

It is another object of the invention to disclose an edible powder composition characterized by no residual chlorine taste for the hydration of mammals comprising (a) a member of the group consisting of vaccines, iron-containing compositions, minerals, salts, amino acids, medicaments, vitamins, nutraceuticals, antibiotics and food supplements; (b) at least three members of the group consisting of steviol glycoside, citric acid monohydrate, monosodium glutamate, glycine, mixtures and derivatives thereof and (c) prebiotic.

It is another object of the invention to disclose an apple flavoured horses' edible powder characterized by no residual chlorine taste comprising (a) a member of the group consisting of vaccines, iron-containing compositions, minerals, salts, amino, medicaments, vitamins, nutraceuticals, antibiotics and food supplements; (b) at least three members of a group consisting steviol glycoside, citric acid monohydrate, monosodium glutamate, glycine, mixtures and derivatives thereof; and (c) An apple-flavouring agent.

It is another object of the invention to disclose an apple flavoured horses' edible powder characterized by no residual chlorine taste comprising (a) a member of the group consisting of vaccines, iron-containing compositions, minerals, salts, amino acids, medicaments, vitamins, nutraceuticals, antibiotics and food supplements; (b) at least three members of the group consisting of steviol glycoside, citric acid monohydrate, monosodium glutamate, glycine, mixtures and derivatives thereof; (c) An apple-flavouring agent; and (d) prebiotic.

It is another object of the invention to disclose an ral isotonic compositions characterized by chicken flavour and no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an oral isotonic composition characterized by chicken flavour and no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

It is another object of the invention to disclose isotonic drink characterized by chicken flavour and no residual chlorine taste for the hydration of mammals comprising at least three members of the group consisting of steviol glycoside, citric acid monohydrate, monosodium glutamate, glycine, mixtures and derivatives thereof; and any derivatives and mixtures thereof.

It is another object of the invention to disclose an isotonic drink composition characterized by chicken flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

It is another object of the invention to disclose an isotonic taste enhancer characterized by chicken flavour and no residual chlorine taste for the hydration of mammals comprising at least three members of a group consisting steviol glycoside, citric acid monohydrate, monosodium glutamate, glycine, mixtures and derivatives thereof.

It is another object of the invention to disclose an isotonic taste enhancer characterized by chicken flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

It is another object of the invention to disclose an edible powder characterized by chicken flavour and no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an edible powder characterized by chicken flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

It is another object of the invention to disclose an edible gel characterized by chicken flavour and no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an edible gel composition characterized by chicken flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

It is another object of the invention to disclose an edible isotonic gel characterized by chicken flavour and no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an edible isotonic gel composition characterized by chicken flavour and no residual chlorine taste for the hydration of mammals comprising (a) at least three members of a group consisting steviol glycoside, citric acid monohydrate, monosodium glutamate, glycine, mixtures and derivatives thereof and (b) prebiotic any derivatives and mixtures thereof.

It is another object of the invention to disclose a solid shear thinning thixotropic edible gel characterized by chicken flavour and no residual chlorine taste for the hydration of mammals comprising at least three members of the group consisting of steviol glycoside, citric acid monohydrate, monosodium glutamate, glycine, mixtures and derivatives thereof.

It is another object of the invention to disclose a solid shear thinning thixotropic edible gel characterized by chicken flavour and no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

It is another object of the invention to disclose an oral isotonic composition characterized by fish flavour and no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an oral isotonic composition characterized by fish flavour and no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

It is another object of the invention to disclose an isotonic drink characterized by fish flavour and no residual chlorine taste for the hydration of mammals comprising at least three members of the group consisting of steviol glycoside, citric acid monohydrate, monosodium glutamate, glycine, mixtures and derivatives thereof; and any derivatives and mixtures thereof.

It is another object of the invention to disclose an isotonic drink composition characterized by fish flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

It is another object of the invention to disclose an isotonic taste enhancer characterized by fish flavour and no residual chlorine taste for the hydration of mammals comprising at least three members of a group consisting steviol glycoside, citric acid monohydrate, monosodium glutamate, glycine, mixtures and derivatives thereof.

It is another object of the invention to disclose an isotonic taste enhancer characterized by fish flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

It is another object of the invention to disclose an edible powder characterized by fish flavour and no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an edible powder characterized by fish flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

It is another object of the invention to disclose an edible gel characterized by fish flavour and no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an edible gel composition characterized by fish flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

It is another object of the invention to disclose an edible isotonic gel characterized by fish flavour and no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an edible isotonic gel composition characterized by fish flavour and no residual chlorine taste for the hydration of mammals comprising (a) at least three members of a group consisting steviol glycoside, citric acid monohydrate, monosodium glutamate, glycine, mixtures and derivatives thereof and (b) prebiotic any derivatives and mixtures thereof.

It is another object of the invention to disclose an solid shear thinning thixotropic edible gel characterized by fish flavour and no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an solid shear thinning thixotropic edible gel characterized by fish flavour and no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

It is another object of the invention to disclose an oral isotonic composition characterized by beef flavour and no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an oral isotonic composition characterized by beef flavour and no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

It is another object of the invention to disclose an isotonic drink characterized by beef flavour and no residual chlorine taste for the hydration of mammals comprising at least three members of the group consisting of steviol glycoside, citric acid monohydrate, monosodium glutamate, glycine, mixtures and derivatives thereof; and any derivatives and mixtures thereof.

It is another object of the invention to disclose an isotonic drink composition characterized by beef flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

It is another object of the invention to disclose an isotonic taste enhancer characterized by beef flavour and no residual chlorine taste for the hydration of mammals comprising at least three members of a group consisting steviol glycoside, citric acid monohydrate, monosodium glutamate, glycine, mixtures and derivatives thereof.

It is another object of the invention to disclose an isotonic taste enhancer characterized by beef flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

It is another object of the invention to disclose an edible powder characterized by beef flavour and no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an edible powder characterized by beef flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

It is another object of the invention to disclose an edible gel characterized by beef flavour and no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an edible gel composition characterized by beef flavour and no residual chlorine taste for the hydration of mammals comprising at least three members of a group consisting (a) steviol glycoside, citric acid monohydrate, monosodium glutamate, glycine, mixtures and derivatives thereof and (b) prebiotic any derivatives and mixtures thereof.

It is another object of the invention to disclose an edible isotonic gel characterized by beef flavour and no residual chlorine taste for the hydration of mammals comprising at least three members of the group consisting of steviol glycoside, citric acid monohydrate, monosodium glutamate, glycine, mixtures and derivatives thereof.

It is another object of the invention to disclose an edible isotonic gel composition characterized by beef flavour and no residual chlorine taste for the hydration of mammals comprising (a) at least three members of a group consisting steviol glycoside, citric acid monohydrate, monosodium glutamate, glycine, mixtures and derivatives thereof and (b) prebiotic any derivatives and mixtures thereof.

It is another object of the invention to disclose a solid shear thinning thixotropic edible gel characterized by beef flavour and no residual chlorine taste for the hydration of mammals comprising at least three members of the group consisting of steviol glycoside, citric acid monohydrate, monosodium glutamate, glycine, mixtures and derivatives thereof.

It is another object of the invention to disclose a solid shear thinning thixotropic edible gel characterized by beef flavour and no residual chlorine taste for the hydration of mammals comprising (a) at least three members of a group consisting of steviol glycoside, citric acid monohydrate, monosodium glutamate, glycine, mixtures and derivatives thereof; and (b) prebiotic any derivatives and mixtures thereof.

It is still another object of the invention to disclose a method selected from the group consisting of enhancing palatability, fast hydrating, gut activity supporting, providing micro-nutrition supplementation, and enhancing digestion and absorption; wherein said method comprises a step of administering to a mammal a composition as defined in any of the above.

It is an object of this invention to provide a method of inducing an animal to increase its water intake, comprising providing to said animal a water composition comprising a meat or chicken hydrolysate, meat or chicken flavorings, at least one sweetener, and at least one component selected from glutamic acid or monosodium glutamate.

It is another object of this invention to provide a method of producing a solution for inducing an animal to increase its water intake comprising mixing a meat or chicken hydrolysate, meat or chicken flavorings, water, at least one sweetener, and at least one component selected from glutamic acid or monosodium glutamate.

It is a further object of this invention to provide a method of inducing an animal to increase its' water intake, wherein said animals are cats and dogs.

### BRIEF DESCRIPTION OF THE FIGURES

The present invention will be readily understood by the following detailed description, in conjunction with the accompanying drawings and in which:

FIG. 1 depicts a non-limiting example of a preferred gel embodiment of the current invention;

FIG. 2 depicts a second non-limiting example of a preferred gel embodiment of the current invention;

FIG. 3 depicts shows the average cat consumption of a composition for cats disclosed in the present application vs. consumption of water;

FIG. 4 depicts shows results of initial palatability test (“first choice”) for cats offered water and a composition for cats disclosed in the present application;

FIG. 5 shows results of initial palatability test (“first choice”) for dogs offered water and a composition for dogs disclosed in the present application;

FIG. 6 shows the average dog consumption of a composition for dogs disclosed in the present application vs. consumption of water;

FIGS. 7A and 7B present graphs illustrating the population distribution by weight of piglet population in a study of pre- and post-weaning mortality;

FIG. 8 presents a graph showing the distribution of piglets in the studies discussed in the examples that died prior to weaning as a function of birthweight;

FIG. 9 presents a graph comparing the body weights of piglets that died prior to weaning with the body weights of their live counterparts;

FIG. 10 presents a graph comparing pre-weaning mortality of piglets provided with the composition disclosed herein with a control group not so provided for piglets of different birthweight categories;

FIG. 11 presents a graph comparing water intake during the first five days post-weaning for piglets provided with the composition disclosed herein with a control group that was not so provided; and,

FIG. 12 presents a graph comparing the mortality rates and number of fall-behinds of piglets provided with the composition disclosed herein with a control group that was not so provided.

### DETAILED DESCRIPTION OF THE PREFERRED EMBODIMENTS

The following description is provided to enable any person skilled in the art to make use of said invention and sets forth the best modes contemplated by the inventors for carrying out this invention. Although the present invention is described herein in terms of specific embodiments, it is anticipated that alterations and modifications to this invention will no doubt become apparent to those skilled in the art and may be practiced within the scope and equivalents of the appended claims. The disclosed embodiments are illustrative and not restrictive, and the invention is not to be limited to the details given herein. There are many alternative ways of implementing the invention. It is therefore intended that the disclosure and following claims be interpreted as covering all such alterations and modifications as fall within the true spirit and scope of the invention.

All references cited herein are intended to be incorporated by reference.

As used herein after, the terms “pet” or “companion animal” interchangeably refer hereinafter to an animal kept primarily for a person's company, protection, or entertainment rather than as a working animal, livestock, or laboratory animal. Popular pets are often noted for their attractive appearances, intelligence, and relatable personalities. Two of the most popular pets are dogs and cats. Other animals commonly kept include: pigs, ferrets, rabbits; rodents, such as gerbils, hamsters, chinchillas, rats, and guinea pigs; avian pets, such as parrots, passerines, and fowl; reptile pets, such as turtles, lizards and snakes; aquatic pets, such as fish, freshwater and saltwater snails, and frogs; and arthropod pets, such as tarantulas and hermit crabs.

As used hereinafter, the term “steviol” generally refers to steviol glycoside, Rebaudioside A extract.

As used herein, with respect to numerical quantities, unless otherwise specified, the term “about” refers to a tolerance of ±25% about the nominal value.

As used herein, the term “granulated” refers to a solid or mixture of solids in the form of particles or granules. Unless otherwise specified, when used generically, the term is used without reference to the size of the particles, and includes, as non-limiting examples, powders (which generally have particle diameters of order of magnitude 1-10 μm) and substances that more commonly referred to as “granulated” and which generally have particle diameters of order of magnitude 100-1000 μm.

As used herein, unless explicitly defined otherwise, the term “isotonic” refers to a solution that has an osmolarity of about 300 mOsm/L, the osmolarity of a 0.9% NaCl solution. Likewise, unless explicitly defined otherwise, the expression “hypotonic” refers to a solution that has a tonicity of less than 250 mOsm/L, and the expression “hypertonic” to a solution that has a tonicity of greater than 350 mOsm/L.

Unless explicitly stated otherwise, when expressed as percentages, concentrations of components of solid compositions are percent by weight, and concentrations of components of solutions are percent w/v.

The present invention discloses compositions for improving hydration in animals. The compositions are produced as dry mixtures, preferably in a granulated form (powder or granules). They are generally supplied to the animal in the form of an aqueous solution of the composition in which the dry mixture is diluted to provide predetermined concentrations of the components of the composition, or in the form of an edible gel. The dry mixtures, the solutions of the dry mixtures, and gels produced from the dry mixtures are all considered by the inventors as being within the scope of the invention.

The present invention also discloses an associated method of providing said compositions to cats or dogs. These compositions are water based, and contain additives palatable to cats or dogs, thereby increasing water intake. The palatable additives comprise meat/chicken hydrolysates and/or flavoring, a sweet flavor, and glutamic acid (umami flavor).

For formulations intended for rehydration of cats and dogs, the water used to dilute the dry mix is preferably chlorine-free (e.g., demineralized or distilled), since cats and dogs prefer not to drink tap water containing chlorine.

In one embodiment, a composition for increasing fluid intake in cats comprises water, glucose, sodium chloride, potassium chloride, glycine, liquid liver hydrolysate, glutamic acid or monosodium glutamate, and taurine.

In another other embodiment, the composition for increasing fluid intake in cats further comprises at least one additional component, selected from the group consisting of xanthan gum, monosodium phosphate, meat or chicken flavouring, and fructo-oligosaccharides that have prebiotic characteristics.

In another embodiment, a composition for increasing fluid intake in dogs comprises: water, glucose, sodium chloride, potassium chloride, glycine, liquid liver hydrolysate, meat or chicken flavouring, and glutamic acid or monosodium glutamate.

In another embodiment, the composition for increasing fluid intake in dogs further comprises at least one additional component, selected from the group consisting of monosodium phosphate, fructo-oligosaccharides that have prebiotic characteristics, xanthan gum as a thickener, and rebaudioside A.

In another embodiment, the composition for increasing fluid intake in dogs further comprises burnt sugar syrup.

The current invention discloses oral chlorine-free compositions for hydration of humans and animals, characterized by enhanced palatability, fast hydration, gut support activity, micro-nutrition supplementation, and enlaced digestion and absorption. It is in the scope of the invention wherein aforesaid non-genetically-modified compositions, products and formulations comprising or based on the commercially available Px™ by Tonisity International Ltd, namely, a composition, e.g., defined below:

TABLE 1

| Ingredients | (%) |
|---|---|
| glucose anhydrous | 1.5540 |
| monosodium glutamate | 0.3900 |
| sodium chloride, vacuum dried | 0.2201 |
| citric acid anhydrous | 0.1860 |
| potassium chloride | 0.1500 |
| glycine | 0.1500 |
| hydrolyzed whey protein isolate | 0.1500 |
| monosodium dihydrogen phosphate | 0.1000 |
| xanthan gum (thickener) | 0.0500 |
| l-glutamic acid | 0.0400 |
| stevia (min. 85% steviol glycoside, | 0.0100 |
| Rebaudioside A extract) | |
| Total ingredients | 3.0000 |
| demineralized water | 97.000 |

The composition consists at least two members of the group consisting of steviol glycoside, citric acid monohydrate, monosodium glutamate and glycine, this composition characterized by that that the composition consists at least three members of the group consisting of steviol glycoside, citric acid monohydrate, monosodium glutamate and glycine. Additionally or alternatively, this composition is characterized by that that said composition consisting of steviol glycoside, citric acid monohydrate, monosodium glutamate and glycine.

Additionally or alternatively, the composition of the current invention also discloses a flavouring agent selected form the group consisting of apple, chicken, beef or fish flavours, with or without prebiotics, and any derivatives and mixtures thereof.

Additionally or alternatively, the composition of the current invention is a palatable carrier of at least one compound of the group consisting of vaccines, iron-containing compositions, minerals, salts, amino acids, medicaments, vitamins, nutraceuticals, antibiotics and food supplements, for nourishing and treating mammals. Thus, the composition of the current invention overcomes the risks of needle administration of the compounds, decreases labor and manpower needed for injecting the treated mammals, and increasing compliance to treatment.

The current invention discloses compositions comprising isotonic drinks (ready-to-use liquids), isotonic edible powders, isotonic taste enhancer, e.g., fluid, edible solid or gel-formed taste enhancer, edible meal toppers (“Gravy”), a treat etc., characterized by no residual chlorine taste for the hydration of mammals, such as cats, dogs, horses, and mink.

These compositions of the current invention compositions comprise:

Equine formulations: formulations for feeding horses of all type of services: horses for work, sport entrainment, culture, warfare, and for therapeutic uses.

These equine formulations comprise e.g., one of the followings:

An apple flavoured horses' isotonic drink characterized by no residual chlorine taste comprising (a) at least three members of a group consisting steviol glycoside, citric acid monohydrate, monosodium glutamate, glycine, mixtures and derivatives thereof; and (b) an apple-flavouring agent.

An apple flavoured horses' isotonic drink characterized by no residual chlorine taste comprising (a) at least three members of a group consisting steviol glycoside, citric acid monohydrate, monosodium glutamate, glycine, mixtures and derivatives thereof; (b) An apple-flavouring agent; and (c) prebiotic.

An isotonic apple flavoured horses' taste enhancer characterized by no residual chlorine taste comprising (a) at least three members of a group consisting steviol glycoside, citric acid monohydrate, monosodium glutamate, glycine, mixtures and derivatives thereof; and (b) an apple-flavouring agent.

An isotonic Apple flavoured horses' taste enhancer characterized by no residual chlorine taste comprising (a) at least three members of a group consisting steviol glycoside, citric acid monohydrate, monosodium glutamate, glycine, mixtures and derivatives thereof; (b) an apple-flavouring agent; and (c) prebiotic.

An apple flavoured horses' edible powder characterized by no residual chlorine taste comprising (a) at least three members of a group consisting steviol glycoside, citric acid monohydrate, monosodium glutamate, glycine, mixtures and derivatives thereof; and (b) an apple-flavouring agent.

An apple flavoured horses' edible powder characterized by no residual chlorine taste comprising (a) at least three members of a group consisting steviol glycoside, citric acid monohydrate, monosodium glutamate, glycine, mixtures and derivatives thereof; (b) An apple-flavouring agent; and (c) prebiotic.

An apple flavoured horses' edible isotonic gel characterized by no residual chlorine taste comprising (a) at least three members of a group consisting steviol glycoside, citric acid monohydrate, monosodium glutamate, glycine, mixtures and derivatives thereof; and (b) an apple-flavouring agent.

An apple flavoured horses' edible isotonic gel characterized by no residual chlorine taste comprising (a) at least three members of a group consisting steviol glycoside, citric acid monohydrate, monosodium glutamate, glycine, mixtures and derivatives thereof; (b) an apple-flavouring agent; and (c) prebiotic.

An apple flavoured horses' solid shear thinning thixotropic edible gel characterized by no residual chlorine taste comprising (a) at least three members of a group consisting steviol glycoside, citric acid monohydrate, monosodium glutamate, glycine, mixtures and derivatives thereof; and (b) an apple-flavouring agent.

An apple flavoured horses' solid shear thinning thixotropic edible gel characterized by no residual chlorine taste comprising (a) at least three members of a group consisting steviol glycoside, citric acid monohydrate, monosodium glutamate, glycine, mixtures and derivatives thereof; (b) an apple-flavouring agent; and (c) prebiotic.

An apple flavoured horses' isotonic drink characterized by no residual chlorine taste comprising (a) a member of the group consisting of vaccines, iron-containing compositions, minerals, salts, amino acids, medicaments, vitamins, nutraceuticals, antibiotics and food supplements; (b) at least three members of the group consisting of steviol glycoside, citric acid monohydrate, monosodium glutamate, glycine, mixtures and derivatives thereof; and (c) an apple-flavouring agent.

An apple flavoured horses' isotonic drink characterized by no residual chlorine taste comprising (a) a member of the group consisting of vaccines, iron-containing compositions, minerals, salts, amino acids, medicaments, vitamins, nutraceuticals, antibiotics and food supplements; (b) at least three members of the group consisting of steviol glycoside, citric acid monohydrate, monosodium glutamate, glycine, mixtures and derivatives thereof; (c) An apple-flavouring agent; and (d) prebiotic.

An apple flavoured horses' edible powder characterized by no residual chlorine taste comprising (a) a member of the group consisting of vaccines, iron-containing compositions, minerals, salts, amino, medicaments, vitamins, nutraceuticals, antibiotics and food supplements; (b) at least three members of a group consisting steviol glycoside, citric acid monohydrate, monosodium glutamate, glycine, mixtures and derivatives thereof; and (c) An apple-flavouring agent.

An apple flavoured horses' edible powder characterized by no residual chlorine taste comprising (a) a member of the group consisting of vaccines, iron-containing compositions, minerals, salts, amino acids, medicaments, vitamins, nutraceuticals, antibiotics and food supplements; (b) at least three members of the group consisting of steviol glycoside, citric acid monohydrate, monosodium glutamate, glycine, mixtures and derivatives thereof (c) an apple-flavouring agent; and (d) prebiotic.

A non-limiting example for horse formulation is Px-E version 3, see Table 2.

Topper formulations: taste enhancers, formulations for enhancing palatably of commercially available dry food for pets.

These topper formulations comprise:

An isotonic taste enhancer, e.g., fluid, solid or gel-formed taste enhancer, edible meal topper, a treat tec., characterized by no residual chlorine taste for the hydration of mammals comprising at least three members of a group consisting steviol glycoside, citric acid monohydrate, monosodium glutamate, glycine, mixtures and derivatives thereof.

An isotonic taste enhancer characterized by no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

An isotonic taste enhancer characterized by no residual chlorine taste for the hydration of mammals comprising at least three members of the group consisting of steviol glycoside, citric acid monohydrate, monosodium glutamate, glycine, mixtures and derivatives thereof.

An isotonic taste enhancer composition characterized by no residual chlorine taste for the hydration of mammals comprising (a) at least three members of a group consisting steviol glycoside, citric acid monohydrate, monosodium glutamate, glycine, mixtures and derivatives thereof; and (b) prebiotic.

An isotonic taste enhancer characterized by chicken flavour and no residual chlorine taste for the hydration of mammals comprising at least three members of a group consisting steviol glycoside, citric acid monohydrate, monosodium glutamate, glycine, mixtures and derivatives thereof.

An isotonic taste enhancer characterized by chicken flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

An isotonic taste enhancer characterized by fish flavour and no residual chlorine taste for the hydration of mammals comprising at least three members of a group consisting steviol glycoside, citric acid monohydrate, monosodium glutamate, glycine, mixtures and derivatives thereof.

An isotonic taste enhancer characterized by fish flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

An isotonic taste enhancer characterized by beef flavour and no residual chlorine taste for the hydration of mammals comprising at least three members of a group consisting steviol glycoside, citric acid monohydrate, monosodium glutamate, glycine, mixtures and derivatives thereof.

An isotonic taste enhancer characterized by beef flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

A non-limiting example for a topper formulation is XDG version 2 or version 3, see Table 3.

Ready-to-use liquid formulations: non-chlorine isotonic drink formulations.

These ready-to-use drink formulations comprise:

An isotonic drink characterized by no residual chlorine taste for the hydration of mammals comprising at least three members of the group consisting of steviol glycoside, citric acid monohydrate, monosodium glutamate, glycine, mixtures and derivatives thereof; and any derivatives and mixtures thereof.

An isotonic drink composition characterized by no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

An isotonic drink characterized by no residual chlorine taste for the hydration of mammals comprising (a) a member of the group consisting of vaccines, iron-containing compositions, minerals, salts, amino acids, medicaments, vitamins, nutraceuticals, antibiotics and food supplements; and (b) at least three members of the group consisting of steviol glycoside, citric acid monohydrate, monosodium glutamate, glycine, mixtures and derivatives thereof; and any derivatives and mixtures thereof.

An isotonic drink composition characterized by no residual chlorine taste for the hydration of mammals comprising (a) a member of the group consisting of vaccines, iron-containing compositions, minerals, salts, amino acids, medicaments, vitamins, nutraceuticals, antibiotics and food supplements; and (b) at least three members of a group consisting steviol glycoside, citric acid monohydrate, monosodium glutamate, glycine, mixtures and derivatives thereof; and (c) prebiotic any derivatives and mixtures thereof.

An isotonic drink characterized by chicken flavour and no residual chlorine taste for the hydration of mammals comprising at least three members of the group consisting of steviol glycoside, citric acid monohydrate, monosodium glutamate, glycine, mixtures and derivatives thereof; and any derivatives and mixtures thereof.

An isotonic drink composition characterized by chicken flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

An isotonic drink characterized by fish flavour and no residual chlorine taste for the hydration of mammals comprising at least three members of the group consisting of steviol glycoside, citric acid monohydrate, monosodium glutamate, glycine, mixtures and derivatives thereof; and any derivatives and mixtures thereof.

An isotonic drink composition characterized by fish flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

An isotonic drink characterized by beef flavour and no residual chlorine taste for the hydration of mammals comprising at least three members of the group consisting of steviol glycoside, citric acid monohydrate, monosodium glutamate, glycine, mixtures and derivatives thereof; and any derivatives and mixtures thereof.

An isotonic drink composition characterized by beef flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

A non-limiting example for a ready-to-use liquid for dogs is X-D liver version 3, see Table 4. A non-limiting example for a ready-to-use liquid is an isotonic liquid for cats version 1, see Table 7.

Powder formulations: fast hydration palatable oral edible formulations.

These powder edible formulations comprise:

An edible powder characterized by no residual chlorine taste for the hydration of mammals comprising at least three members of the group consisting of steviol glycoside, citric acid monohydrate, monosodium glutamate, glycine, mixtures and derivatives thereof.

An edible powder characterized by no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

An edible powder characterized by no residual chlorine taste for the hydration of mammals comprising at least three members of the group consisting of steviol glycoside, citric acid monohydrate, monosodium glutamate, glycine, mixtures and derivatives thereof.

An edible powder composition characterized by no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

An edible powder characterized by no residual chlorine taste for the hydration of mammals comprising (a) a member of the group consisting of vaccines, iron-containing compositions, minerals, salts, amino acids, medicaments, vitamins, nutraceuticals, antibiotics and food supplements; and (b) at least three members of the group consisting of steviol glycoside, citric acid monohydrate, monosodium glutamate, glycine, mixtures and derivatives thereof.

An edible powder characterized by no residual chlorine taste for the hydration of mammals comprising (a) a member of the group consisting of vaccines, iron-containing compositions, minerals, salts, amino acids, medicaments, vitamins, nutraceuticals, antibiotics and food supplements; (b) at least three members of the group consisting of steviol glycoside, citric acid monohydrate, monosodium glutamate, glycine, mixtures and derivatives thereof and (c) prebiotic any derivatives and mixtures thereof.

An edible powder characterized by no residual chlorine taste for the hydration of mammals comprising (a) a member of the group consisting of vaccines, iron-containing compositions, minerals, salts, amino acids, medicaments, vitamins, nutraceuticals, antibiotics and food supplements; (b) at least three members of the group consisting of steviol glycoside, citric acid monohydrate, monosodium glutamate, glycine, mixtures and derivatives thereof.

An edible powder composition characterized by no residual chlorine taste for the hydration of mammals comprising (a) a member of the group consisting of vaccines, iron-containing compositions, minerals, salts, amino acids, medicaments, vitamins, nutraceuticals, antibiotics and food supplements; (b) at least three members of the group consisting of steviol glycoside, citric acid monohydrate, monosodium glutamate, glycine, mixtures and derivatives thereof; and (c) prebiotic.

An edible powder characterized by chicken flavour and no residual chlorine taste for the hydration of mammals comprising at least three members of the group consisting of steviol glycoside, citric acid monohydrate, monosodium glutamate, glycine, mixtures and derivatives thereof.

An edible powder characterized by chicken flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

An edible powder characterized by fish flavour and no residual chlorine taste for the hydration of mammals comprising at least three members of the group consisting of steviol glycoside, citric acid monohydrate, monosodium glutamate, glycine, mixtures and derivatives thereof.

An edible powder characterized by fish flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

An edible powder characterized by beef flavour and no residual chlorine taste for the hydration of mammals comprising at least three members of the group consisting of steviol glycoside, citric acid monohydrate, monosodium glutamate, glycine, mixtures and derivatives thereof.

An edible powder characterized by beef flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

A non-limiting example for a powder suitable for dogs is X54 (see Table 5). A non-limiting example for a powder suitable for cats is isotonic powder mix for cats version 1, see Table 8.

Gel formulations: edible isotonic gel formulations, including inter alia firm gel or shear-thinning thixotropic edible gel.

These edible gel formulations comprise:

an edible gel characterized by no residual chlorine taste for the hydration of mammals comprising at least three members of the group consisting of steviol glycoside, citric acid monohydrate, monosodium glutamate, glycine, mixtures and derivatives thereof.

an edible gel composition characterized by no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

an edible isotonic gel characterized by no residual chlorine taste for the hydration of mammals comprising at least three members of the group consisting of steviol glycoside, citric acid monohydrate, monosodium glutamate, glycine, mixtures and derivatives thereof.

an edible isotonic gel composition characterized by no residual chlorine taste for the hydration of mammals comprising (a) at least three members of a group consisting steviol glycoside, citric acid monohydrate, monosodium glutamate, glycine, mixtures and derivatives thereof and (b) prebiotic any derivatives and mixtures thereof.

a solid shear thinning thixotropic edible gel characterized by no residual chlorine taste for the hydration of mammals comprising at least three members of the group consisting of steviol glycoside, citric acid monohydrate, monosodium glutamate, glycine, mixtures and derivatives thereof.

a solid shear thinning thixotropic edible gel characterized by no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

an edible gel characterized by chicken flavour and no residual chlorine taste for the hydration of mammals comprising at least three members of the group consisting of steviol glycoside, citric acid monohydrate, monosodium glutamate, glycine, mixtures and derivatives thereof.

an edible gel composition characterized by chicken flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

an edible isotonic gel characterized by chicken flavour and no residual chlorine taste for the hydration of mammals comprising at least three members of the group consisting of steviol glycoside, citric acid monohydrate, monosodium glutamate, glycine, mixtures and derivatives thereof.

an edible isotonic gel composition characterized by chicken flavour and no residual chlorine taste for the hydration of mammals comprising (a) at least three members of a group consisting steviol glycoside, citric acid monohydrate, monosodium glutamate, glycine, mixtures and derivatives thereof and (b) prebiotic any derivatives and mixtures thereof.

a solid shear thinning thixotropic edible gel characterized by chicken flavour and no residual chlorine taste for the hydration of mammals comprising at least three members of the group consisting of steviol glycoside, citric acid monohydrate, monosodium glutamate, glycine, mixtures and derivatives thereof.

a solid shear thinning thixotropic edible gel characterized by chicken flavour and no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

an edible gel characterized by fish flavour and no residual chlorine taste for the hydration of mammals comprising at least three members of the group consisting of steviol glycoside, citric acid monohydrate, monosodium glutamate, glycine, mixtures and derivatives thereof.

an edible gel composition characterized by fish flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

an edible isotonic gel characterized by fish flavour and no residual chlorine taste for the hydration of mammals comprising at least three members of the group consisting of steviol glycoside, citric acid monohydrate, monosodium glutamate, glycine, mixtures and derivatives thereof.

an edible isotonic gel composition characterized by fish flavour and no residual chlorine taste for the hydration of mammals comprising (a) at least three members of a group consisting steviol glycoside, citric acid monohydrate, monosodium glutamate, glycine, mixtures and derivatives thereof and (b) prebiotic any derivatives and mixtures thereof.

a solid shear thinning thixotropic edible gel characterized by fish flavour and no residual chlorine taste for the hydration of mammals comprising at least three members of the group consisting of steviol glycoside, citric acid monohydrate, monosodium glutamate, glycine, mixtures and derivatives thereof.

a solid shear thinning thixotropic edible gel characterized by fish flavour and no residual chlorine taste for the hydration of mammals comprising (a) at least three members of a group consisting steviol glycoside, citric acid monohydrate, monosodium glutamate, glycine, mixtures and derivatives thereof and (b) prebiotic any derivatives and mixtures thereof.

an edible gel characterized by beef flavour and no residual chlorine taste for the hydration of mammals comprising at least three members of the group consisting of steviol glycoside, citric acid monohydrate, monosodium glutamate, glycine, mixtures and derivatives thereof.

an edible gel composition characterized by beef flavour and no residual chlorine taste for the hydration of mammals comprising at least three members of a group consisting (a) steviol glycoside, citric acid monohydrate, monosodium glutamate, glycine, mixtures and derivatives thereof; and (b) prebiotic any derivatives and mixtures thereof.

an edible isotonic gel characterized by beef flavour and no residual chlorine taste for the hydration of mammals comprising at least three members of the group consisting of steviol glycoside, citric acid monohydrate, monosodium glutamate, glycine, mixtures and derivatives thereof.

an edible isotonic gel composition characterized by beef flavour and no residual chlorine taste for the hydration of mammals comprising (a) at least three members of a group consisting steviol glycoside, citric acid monohydrate, monosodium glutamate, glycine, mixtures and derivatives thereof and (b) prebiotic any derivatives and mixtures thereof.

a solid shear thinning thixotropic edible gel characterized by beef flavour and no residual chlorine taste for the hydration of mammals comprising at least three members of the group consisting of steviol glycoside, citric acid monohydrate, monosodium glutamate, glycine, mixtures and derivatives thereof.

a solid shear thinning thixotropic edible gel characterized by beef flavour and no residual chlorine taste for the hydration of mammals comprising (a) at least three members of a group consisting steviol glycoside, citric acid monohydrate, monosodium glutamate, glycine, mixtures and derivatives thereof; and (b) prebiotic any derivatives and mixtures thereof.

A non-limiting example for an edible gel is firm-gel carrageenan—LBG, see Table ₆.

### Example 1

Problem: Horses that are subjected to long bouts of exercise will lose massive amounts of water and electrolytes. If the horse is not quickly rehydrated, this can become a serious emergency and lead to kidney failure.

Delivery: Powder

Properties: White color (closely resembles Tonisity Px); Pleasant apple aroma and flavouring; and Oral rehydration formula.

Uses: Dry top dressing sprinkled on feed; Mixed with water to create an isotonic solution; Mixed with other feeds (e.g., bran, beet pulp, etc.) to make a mash

Results: In trials, the mash and top dressing were very well received

Trials indicated that horses had better exercise tolerance, improved stamina and demeanor, and generally more energy.

Intended Uses: For working horses performing heavy exercise; after 3-day events; dressage horses; and Long-distance riding and racing.

Package Size Suggestions: 155 g scoop of the powder per horse per day, so package could be 1 or 2.5 kg.

The composition of a preferred embodiment of a horse nourishing formulation, Px-E version 3, is given in Table 2. The composition of the dry mix formulation is given along with a typical preparation of a formulation as a 3% (w/v) aqueous solution of the dry mix (3 g dry mix/100 ml solution).

TABLE 2

| Ingredients | Solution (%) | Dry mix (%) |
|---|---|---|
| Demineralised Water | 97.000 | |
| Glucose Anhydrous | 1.674 | 55.800 |
| Sodium Chloride | 0.220 | 7.334 |
| Potassium Chloride | 0.150 | 5.000 |
| Glycine | 0.150 | 5.000 |
| Xanthan Gum | 0.050 | 1.667 |
| Monosodium Phosphate | 0.100 | 3.333 |
| Citric Acid Anhydrous | 0.060 | 2.000 |
| Hydrolysed Whey Protein Isolate | 0.150 | 5.000 |
| L-Glutamic Acid | 0.040 | 1.333 |
| Monosodium Glutamate | 0.390 | 13.000 |
| Rebaudioside A 98% Min. | 0.010 | 0.333 |
| Thaumatin | 0.003 | 0.100 |
| Apple Flavour Maxarome Ac 1632 | 0.003 | 0.100 |
| Total | 100.000 | 100.000 |

### Example 2

Topper (Gravy) for dogs—Gravy topper, XDG version 2 and version 3. The difference between the two formulations is a higher viscosity in version 3 (XDG3).

Problem: Dry food historically has lacked palatability for dogs. To maintain a healthy physique and internal equilibrium, a tasty and vitamin-rich “meal topper” can be poured over the dry food. These gravies can come with different flavouring that targets a specific health improvement such as joint and bone, shiny coat, etc.

Delivery: Gravy/Puree

Properties: Prebiotic formula (oligosaccharides); Rich, meaty flavour with a thicker consistency; Target Audience: Offers a more diversified diet and a meal of pleasure for all dogs. Recreational usage and also to enhance the quality of the less healthy food; Older dogs who have trouble drinking enough water

Benefits and Uses: Palatable flavour for dogs, delivering nutrients and vitamins through an isotonic delivery system; and Ready to use—no preparation required before serving, just pour on top of standard dry food.

The compositions of two preferred non-limiting embodiments of a topper formulation, XDG version 2 and version 3, are given in Table 3. In these embodiments, the formulation comprises a ˜5% (w/v) aqueous solution of dry mix (˜5 g dry mix/100 ml solution).

TABLE 3

| | XDG V2 | XDG V3 |
|---|---|---|
| Ingredients | % | % |
| Demineralized Water | 95.04 | 94.84 |
| Glucose Anhydrous | 1.60 | 1.60 |
| Sodium Chloride | 0.22 | 0.22 |
| Potassium Chloride | 0.15 | 0.15 |
| Glycine | 0.15 | 0.15 |
| Xanthan Gum | 0.20 | 0.40 |
| Monosodium Phosphate | 0.10 | 0.10 |
| Liquid Liver Hydrolysate | 2.00 | 2.00 |
| Oligosaccharide | 0.10 | 0.10 |
| L-Glutamic Acid | 0.04 | 0.04 |
| Monosodium Glutamate | 0.19 | 0.19 |
| Burnt Sugar | 0.20 | 0.20 |
| Rebaudioside A (Steviol Glycoside A) | 0.01 | 0.01 |
| 98% Min. | | |
| Total | 100.00 | 100.00 |

Preparation: premix all dry ingredients before addition to water; pH 3.8-4.2 at 20° C.

### Example 3

Ready-to-use liquid for dogs: X-D Liver hydrosylate version 3.

Problem: Most dogs do not prefer to drink tap water that contains chlorine. Both chlorine and ammonia are products that not only give off strong odors that dogs hate, but are also highly harmful to them; see https://www.animalwised.com/top-10-smells-dogs-hateA-1568.html; incorporated herein as reference. Additionally, there does not exist any hydration liquid in the pet retail market aimed at providing nutrients and electrolyte replenishment to cats. The industry is hyper-focused on food products, leaving a huge missed opportunity for liquids. This RTU liquid can only be compared to Oralade (sold only in Europe), from which this formula is derived.

Delivery: Liquid

Properties: Fast hydration with an isotonic delivery system; Ready-to-use and palatable oral hydration liquid; Pleasant chicken aroma and taste; and Prebiotic formula (oligosaccharides)

Audience: All dogs, especially those who have been exercising, working or are recovering from illness. Benefits and Uses: Ready to use formula with no mixing required; Provides fast and efficient hydration while promoting gut health through simple amino acids and prebiotics with an isotonic delivery system; Recommended for pets requiring rehydration due to recreational activities: exercise, travel, hot weather; and Convenient when on-the-go; Packaging Sizes: Could have a variety of these.

The composition of a preferred non-limiting embodiment of a topper formulation is given in Table 4. In this embodiment, the formulation comprises a ˜5% (w/v) solution of dry mix in water (˜5 g dry mix/100 ml water).

TABLE 4

| Ingredients | % |
|---|---|
| Demineralized Water | 95.32 |
| Glucose Anhydrous | 1.60 |
| Sodium Chloride | 0.22 |
| Potassium Chloride | 0.15 |
| Glycine | 0.15 |
| Monosodium Phosphate | 0.10 |
| Xanthan Gum | 0.12 |
| Mercey C14028 Liver Hydrolysate | 2.00 |
| Oligosaccharide | 0.10 |
| L-Glutamic Acid | 0.04 |
| Monosodium Glutamate | 0.19 |
| Rebaudioside A 98% Min | 0.01 |
| Total | 100.00 |

### Example 4

Powder for dogs: X54 spray dried liver hydrolysate version 2

Problem: Inconvenient and heavy water bottles make it more difficult to take your dog to the outdoors and for recreational exercise. These lightweight single servings make it easy to deliver electrolytes and rehydration to your dog.

Delivery: Powder

Properties: Fast hydration with an isotonic delivery system; Ready-to-use and palatable oral hydration powder; Pleasant chicken aroma and taste; and Prebiotic formula (oligosaccharides)

Benefits and Uses: Mixes readily with water, light shaking required; Very portable and lightweight: great for traveling, hiking, camping, exercise; Provides fast and efficient hydration while promoting gut health through simple amino acids and prebiotics with an isotonic delivery system; Recommended for pets requiring rehydration due to recreational activities: exercise, travel, hot weather; and Extremely long shelf life (longer than the Gel and RTU Liquid)

Packaging Sizes: Single serving (mix with 500 mL of water), similar to Crystal Light.

How to Use: Mix the powder with 500 mL of water and pour into an empty bowl.

The composition of a preferred embodiment of a formulation for dogs, X54 Spray Dried Liver Hydrolysate Version 2, is given in Table 5. The dry powder formulation is given along with a typical, non-limiting, formulation in which the composition is a 3.5% (w/v) aqueous solution of the powder (3.5 g powder/100 ml solution).

TABLE 5

| Ingredients | Liquid (%) | Powder (%) |
|---|---|---|
| Demineralized water | 96.50 | |
| Glucose anhydrous | 1.82 | 52.00 |
| Sodium chloride | 0.22 | 6.286 |
| Potassium chloride | 0.15 | 4.286 |
| Glycine | 0.15 | 4.286 |
| Monosodium phosphate | 0.10 | 2.856 |
| Citric acid anhydrous | 0.22 | 6.286 |
| Spray dried liver hydrolysate | 0.50 | 14.286 |
| Oligosaccharide | 0.10 | 2.857 |
| L-glutamic acid | 0.04 | 1.143 |
| Monosodium glutamate | 0.19 | 5.428 |
| Rebaudioside a 98% min. | 0.01 | 0.286 |
| Total | 100.000 | 100.000 |

### Example 5

Gel for dogs: firm gel carrageenan-LBG, (LBG—locust bean gum), see Table 6.

Problem: Providing water to your dog on-the-go requires a portable water bowl, which is inconvenient to carry and use. This palatable hydration gel can be administered on surfaces like grass and sidewalk and require no additional equipment.

Delivery: Gel

Properties: Using an isotonic delivery system (which occurs when the gel reaches the dog's stomach), the gel provides electrolytes and hydration to your dog when they need it most; Provides fast and efficient hydration while promoting gut health through simple amino acids and prebiotics (oligosaccharides) with an isotonic delivery system; and pleasant chicken liver aroma and taste.

Benefits: When walking your dog, no water bowl is required. The gel can be administered on any surface (grass, sidewalk, etc.); Great for recreational exercising, especially in hot weather climates; Stable in a variety of temperature conditions; and Easy to carry and convenient.

Packaging Sizes: Foil bag (250 mL), single serving, or peel-wrapped cubes.

How to Use: Squeeze foil bag onto any surface (grass, sidewalk, etc.). The number of cubes given would depend on the size of the dog.

The composition of a preferred embodiment of an edible gel formulation for dogs is given in Table 6.

TABLE 6

| Ingredients | % |
|---|---|
| Demineralized Water | 95.45 |
| Glucose Anhydrous | 1.69 |
| Sodium Chloride | 0.22 |
| Potassium Chloride | 0.15 |
| Glycine | 0.15 |
| Kappa Carrageenan Gum | 0.60 |
| Locust Bean Gum | 0.60 |
| Xanthan Gum | 0.20 |
| Oligosaccharide | 0.10 |
| Spray Dried Chicken Liver | 0.50 |
| L-Glutamic Acid | 0.04 |
| Monosodium Glutamate | 0.19 |
| Burnt Sugar Syrup | 0.10 |
| Rebaudioside A Min 98% | 0.01 |
| Total | 100.00 |

Preparation of gel: Premix all dry ingredients before addition to water

Disperse and dissolve in water at max 35 degrees C.

Fill into pouches, double seal, immerse for 30 minutes minimum in boiling water. Remove from boiling water, allow to cool.

Additional non-limiting embodiment of gel consists agar and pectin as alternatives to Carrageenan—LBG gelling composition.

### Example 6

Ready-to-use liquid for cats: Isotonic liquid for cats

Problem: Cats are notoriously picky about drinking water. Electrophysiological recordings show that water is not tasteless to cats; see Bartoshuk, L. M., M. A. Harned, and L. H. Parks. “Taste of water in the cat: effects on sucrose preference.” Science 171.3972 (1971): 699-701, which is incorporated in its entirety by reference. However, there does not exist any hydration liquid in the pet retail market aimed at providing nutrients and electrolyte replenishment to cats. The industry is hyper-focused on food products, leaving a huge missed opportunity for liquids. This RTU liquid can only be compared to Oralade (sold only in Europe), from which this formula is derived.

Delivery: Liquid

Properties: Fast hydration with an isotonic delivery system; Ready-to-use and palatable oral hydration liquid; Pleasant chicken or fish aroma and taste; and Prebiotic formula (oligosaccharides).

Benefits and Uses: Ready to use formula with no mixing required; Provides fast and efficient hydration while promoting gut health through simple amino acids and prebiotics with an isotonic delivery system; recommended for pets requiring rehydration due to recreational activities: exercise, travel, hot weather; and Convenient when on-the-go.

Packaging Sizes: Could have a variety of sizes.

How to Use: Pour the contents into an empty bowl.

The composition of a preferred embodiment of an isotonic drink for cats is given in Table 7.

TABLE 7

| Ingredient | % |
|---|---|
| Demineralized Water | 94.20 |
| Glucose Anhydrous | 1.50 |
| Sodium Chloride | 0.15 |
| Potassium Chloride | 0.10 |
| Glycine | 0.30 |
| Monosodium Phosphate | 0.10 |
| Xanthan Gum | 0.12 |
| Liquid Liver Hydrolysate | 3.00 |
| Fructo-Oligosaccharide | 0.10 |
| L-Glutamic Acid | 0.04 |
| Monosodium Glutamate | 0.19 |
| Taurine | 0.08 |
| Liquid Roast Chicken Flavour | 0.12 |
| Total | 100.00 |

Target pH = 3.3-3.6 At 20° c.

### Example 7

Powder for cats: Isotonic edible powder mix for cats, see Table 8.

Problem: It is important to keep your cat hydrated, particularly in high temperature conditions. Particularly if they spend time in the outdoors and in direct sunlight, combined with their meager daily intake of water, an electrolyte replenishment formula can be a critical tool to increase hydration. This is also a good product for older cats who have trouble drinking water or critical care patients who just underwent some medical procedure.

Delivery: Powder

Properties: Fast hydration with an isotonic delivery system; Ready-to-use and palatable oral hydration powder; Pleasant chicken of beef aroma and taste; and Prebiotic formula (oligosaccharides).

Audience: Older cats that have trouble drinking, post-trauma, but also for recreational usage.

Benefits and Uses: Mixes readily with water, light shaking required; Very portable and lightweight; Provides fast and efficient hydration while promoting gut health through simple amino acids and prebiotics with an isotonic delivery system; and Extremely long shelf life (longer than the Gel and RTU Liquid)

Packaging Sizes: Single serving (mix with 100 mL of water)

How to Use: Mix the powder with 100 mL of water and pour into an empty bowl.

The composition of a preferred embodiment of formulation of a powder and an isotonic solution of the powder, corresponding to a dilution to 4% w/v (4 g powder/100 ml solution) is given in Table 8.

TABLE 8

| Ingredients | Liquid (%) | Powder (%) |
|---|---|---|
| Demineralized Water | 96.00 | |
| Glucose Anhydrous | 1.34 | 33.50 |
| Sodium Chloride | 0.20 | 5.00 |
| Potassium Chloride | 0.15 | 3.75 |
| Glycine | 0.30 | 7.50 |
| Monosodium Phosphate | 0.10 | 2.50 |
| Citric Acid Anhydrous | 0.30 | 7.50 |
| Spray Dried Liver Hydrolysate | 1.00 | 25.00 |
| Fructo-Oligosaccharide | 0.10 | 2.50 |
| L-Glutamic Acid | 0.04 | 1.00 |
| Monosodium Glutamate | 0.19 | 4.75 |
| Taurine | 0.08 | 2.00 |
| Roast Chicken Flavour Powder | 0.20 | 5.00 |
| Total | 100.00 | 100.00 |

### Example 8

The oral composition for cats was prepared, according to the composition provided in Table 1 below. The dry ingredients were premixed and added to liquid ingredients. The solution was then heated to 95° C., after which the product was filled into Polyethylene terephthalate (PET) bottles at a temperature of at least 85° C. and held for 5 minutes to ensure pasteurization.

A palatability test for examining the effect of the composition of Table 1 on hydration in cats was carried out. These tests were carried out over a period of three days, with a cohort of 20 cats. The average weight of the cats was 4.5 kg. The cats were individually housed during feeding time. For the rest of the day, the cats were in groups in the playground. Each cat was offered two bowls, one containing 250 gr of plain water, and the second containing 250 gr of a composition of Table 1. There were two elements to the test: (1) initial palatability (“first choice”) and (2) total quantity consumed. The first choice of each cat was recorded on each day. The quantity consumed from each of the two bowls was measured on each day. The trial was a cross-over design, which means that on the second and third days, the contents of each bowl were replaced for each cat, and positions of each of the two bowls was switched for each cat. This is normal procedure for palatability and consumption trials.

In addition, stool consistency was evaluated, using the following grading system:

1=liquid-watery; 2=liquid-gel; 3=semi-formed; 4=formed; 5=hard-dry

A non-limiting example for oral compositions for cats is shown in Table 9.

TABLE 9

| Ingredient | % (w/w) |
|---|---|
| Demineralized water | 90.7-97.84 |
| Glucose anhydrous | 0.9-1.55 |
| Sodium chloride | 0.1-0.2 |
| Glycine | 0.15-0.4 |
| Potassium chloride | 0.1-0.2 |
| Monosodium phosphate | 0.05-0.5 |
| Xanthan gum | 0.1-0.3 |
| Liquid liver hydrolysate | 0.5-4.0 |
| Fructo-oligosaccharide | 0.05-0.15 |
| L-Glutamic acid | 0.01-0.4 |
| Monosodium glutamate | 0.05-0.8 |
| Taurine | 0.05-0.5 |
| Meat/chicken flavor | 0.1-0.3 |
| Total | 100.00 |

Results:

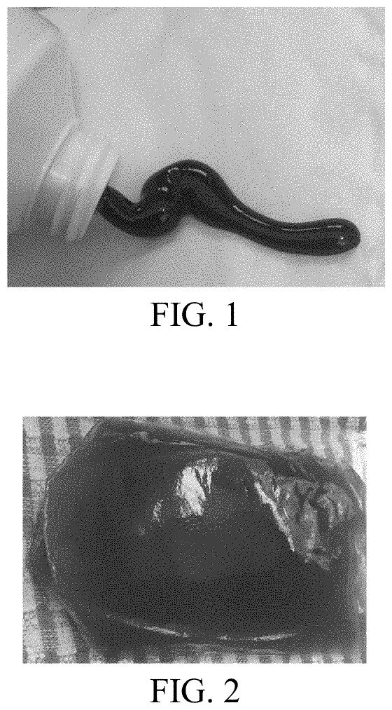

Initial Palatability: As shown in FIG. 2, 69% of cats favored the composition of the present application as their first choice, compared to 31% of the cats favoring water as their first choice. This data shows a clear preference of cats for the composition of the present application, relative to water.

Total quantity consumed: as mentioned above, the consumption from each of the two bowls was measured on each day, and the results shown in FIG. 1. Average intake of the composition of Table 1 was 155 gr/day/cat, which was three times the average weight of water consumed, 51 gr/day/cat. This represents a 3-fold increase in intake of the composition of the present application relative to water, which was statistically significant (P<0.0001).

The average stool grade was found to be 4 which is ‘normal feces’. Thus, it can be concluded that the ingestion of increased liquid weight had no discernable effect on the cats' normal bowel function.

### Example 9

An oral composition for dogs was prepared, according to the composition provided in Table 2 below. The dry ingredients were premixed and added to liquid ingredients. The solution was then heated to 95° C., after which the product was filled into PET bottles at a temperature of 85° C., and held at 85° C. for at least 5 minutes to ensure pasteurization.

A palatability test for examining the effect of the composition of the present application on hydration in dogs was carried out. These tests were carried out over a period of two days, with a group of 30 dogs.

The dogs were housed in a commercial kennel setting. The average weight of the dogs was 13.45 kg (range: 7.2-21.8 kg). The trial was a cross-over design, which means that on the second day, the contents of each bowl were replaced for each dog, and positions of each of the two bowls were switched for each dog. This is normal procedure for palatability and consumption trials with dogs. There were two elements to the test, namely, (1) initial palatability (“first choice”) and (2) total weight consumed. The first choice of each dog was recorded on each day. The quantity consumed from each of the two bowls was measured on each day.

Each dog was offered two bowls, one containing 1000 gr of plain water, and the second containing 1000 gr of the composition of the present application. The first choice of each dog was recorded. The quantity consumed from each of the two bowls was measured. On the second day, the contents of each bowl were replaced, and positions of each of the two bowls was switched.

In addition, stool consistency was evaluated, using the grading system from Example 1:

1=liquid-watery; 2=liquid-gel; 3=semi-formed; 4=formed; 5=hard-dry

A non-limiting example for an oral composition for dogs is shown in Table 10.

TABLE 10

| Ingredient | % (w/w) |
|---|---|
| Demineralized water | 90.8-97.93 |
| Glucose anhydrous | 0.9-2.0 |
| Sodium chloride | 0.1-0.3 |
| Potassium chloride | 0.1-0.2 |
| Glycine | 0.1-0.4 |
| Monosodium phosphate | 0.05-0.3 |
| Xanthan gum | 0.1-0.3 |
| Liquid liver hydrolysate | 0.5-4.0 |
| Fructo-oligosaccharide | 0.05-0.15 |
| L-Glutamic acid | 0.01-0.4 |
| Monosodium glutamate | 0.05-0.8 |
| Rebaudioside A 98% min. | 0.01-0.05 |
| Meat/chicken flavor | 0.1-0.3 |
| Total | 100.00 |

Results:

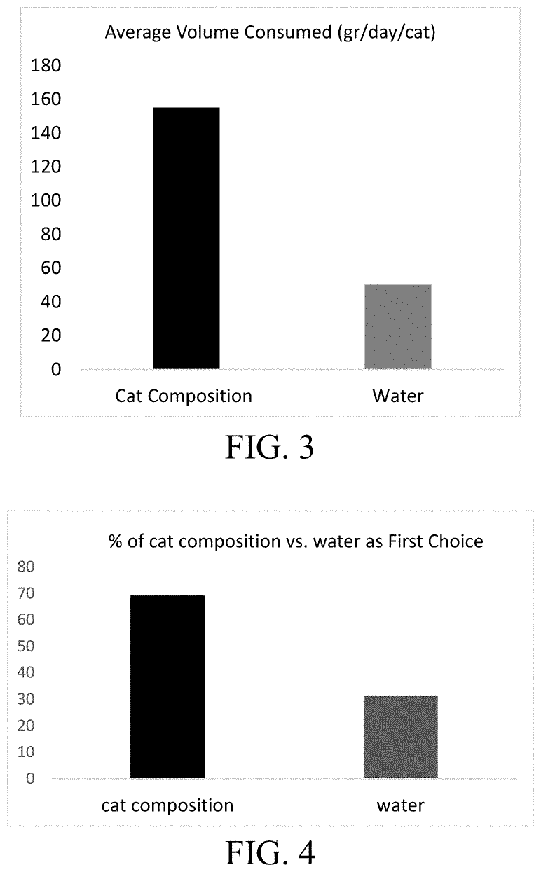

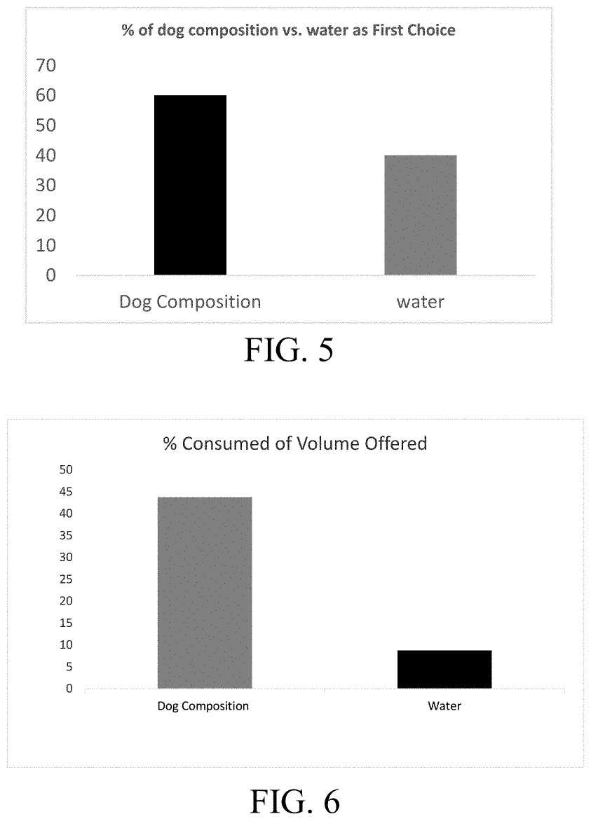

Initial taste preference: As shown in FIG. 3, the majority of dogs were found to prefer the composition of Table 2, with 60% of dogs favoring the composition of Table 2, and only 40% of dogs favoring plain water as their first choice.

Total consumption: As described hereinabove, the consumption from each of the two bowls was measured, and the results are shown in FIG. 4. These data show a clear and statistically significant increase in liquid intake of the composition of the present application, relative to water. The average intake of the composition of the present application was 439 gr/day/dog, compared to an average water intake of 86 gr/day/dog. Overall, during the 2 days, 44% of the composition of the present application offered (1 kg/day/dog) was consumed, compared to consumption of 9% of the weight of water offered (1 kg/day/dog). This was a significantly higher liquid intake of the composition of the present application, compared to water (P<0.0001)

The average stool grade in both treatment groups was found to be: 3-4, which was within the normal limits of semi-formed or formed, indicating that ingestion of the composition of the present application did not have any discernible effect on the dogs' normal bowel function.

### Example 10

Another non-limiting embodiment of the composition disclosed herein was prepared. Typical formulations of the composition as a dry mix and as a ˜7% solution (˜7 g of dry mix/100 ml water) are summarized in Table 11.

TABLE 11

| Component | Dry Mix (%) | Liquid (%) |
|---|---|---|
| Water | — | 92.95 |
| Glucose monohydrate | 20.6 | 1.45 |
| Sodium chloride | 2.8 | 0.2 |
| Potassium chloride | 2.1 | 0.15 |
| Glycine | 2.1 | 0.15 |
| Sodium dihydrogen phosphate | 0.6 | 0.04 |
| Xanthan gum | 5.7 | 0.4 |
| Monosodium glutamate | 1.4 | 0.1 |
| Rebaudioside A 98% min. | 0.1 | 0.01 |
| Fructo-oligosaccharide | 1.4 | 0.1 |
| Liquid liver hydrolysate | 56.7 | 4 |
| Burnt sugar | 5.7 | 0.4 |
| Phosphoric acid | 0.7 | 0.05 |

### Example 11

### Reduction of Pre-Weaning Mortality in Piglets

There is a widely-held perception in swine production systems that pre-weaning mortality (henceforth “PWM”) in piglets is restricted to, or at least largely suffered by, piglets of low birth weight, that most PWM losses are due to losses of low birthweight piglets. Indeed, the interventions and systems developed for PWM management often target specifically the smaller piglets. Considerable effort goes into supporting these piglets in the form of extra care, cross-fostering, creating runt litters, the use of nurse sows, milk replacer systems, dedicated rescue pens and special creep feed. Interventions such as administration of bioactives and nutritional interventions such as administration of electrolytes and milk replacers have not been shown to significantly reduce PWM. The focus of all of these interventions is to increase weight at weaning. The results of these interventions, however, have not been consistent.

This targeting of interventions on lighter piglets is understandable, since dead piglets are often lighter than their live counterparts. It is not well-understood in the prior art, however, whether the dead pigs are those that being born light or if they are losing condition between birth and death. It is also not well-understood in the prior art whether or not population-wide interventions can successfully be applied to reduce piglet mortality.

In fact, while the rate of PWM is higher for piglets of light birth weight (defined as a birth weight of less than 1 kg, henceforth “L-pigs”) than it is for medium and heavy birth weight piglets (1-1.6 kg birth weight, henceforth “M-pigs,” and greater than 1.6 kg birth weight, henceforth “H-pigs,” respectively), since only ˜10% of piglets are of light birth weight, approximately two-thirds of piglets that die before weaning are of medium or heavy birth weight (see, for example, (a) Calderon Diaz, J. A.; Boyle, L. A.; Diana, A.; Leonard, F. C.; Moriarty, J. P.; McElroy, M. C.; McGettrick, S.; Kelliher, D.; Garcia Manzanilla, E. Prev. Vet. Med. 2017, 146, 94-102; (b) Feldpausch, J. A.; Jourquin, J.; Bergstrom, J. R.; Bargen, J. L.; Bokenkroger, C. D.; Davis, D. L.; Gonzalez, J. M.; Nelssen, J. L.; Puls, C. L.; Trout, W. E.; Transl. Anim. Sci. 2019, 3, 633-640).

The immediate post-weaning period is stressful for the piglet, and modern farming methods in which piglets are typically transported to a production facility where they encounter large numbers of unfamiliar piglets shortly after weaning add to this stress (Sutherland, M. A.; Backus, B. L.; McGlone, J. J. Animals (Basel), 2014, 4, 657-669). This stress has been observed to be detrimental to the health of the piglet's digestive system (Xion, X.; Tan, B.; Song, M.; Ji, P.; Kim, K.; Yin, Y.; Liu, Y. Front. Vet. Sci. 2019, 6(46), doi: 10.3389/fvets.2019.00046). It has been observed that feed in the first few days post-weaning is highly correlated with water intake. It is also known that stress such as that caused by weaning can lead to decreased water intake (Carroll, C. In Pig Farmers' Conferences 2003, pp. 3-10; Teagasc: Dublin, 2003). If the water intake of piglets is too low, then the feed intake is reduced, and the feed that is eaten is not digested as well, leading to poor daily weight gain. In the worst case, the piglet suffers dehydration that ultimately leads to death. Thus, in addition to PWM, post-weaning mortality in piglets is a matter of considerable concern as well.

The inventors have found, surprisingly, that administration of embodiments of the composition disclosed herein, in particular, embodiments of the composition in which the glycine concentration of a 3% aqueous solution of the dry mix is less than 0.2%, reduces PWM across all piglet birth weights.

A meta-analysis was performed of 22 independent studies that examined the effects of administration of the composition disclosed herein on piglet growth and PWM. The studies were performed in farms in Brazil, China, Italy, Spain, the UK, and the USA, and involved a total of 32,743 piglets.

PWM vs. age and birth weight analyses involved 10 studies and a total of 706 piglets (only piglets that died were included in this analysis); and the analyses of the effects of administration of the composition disclosed herein involved 15 studies and at total of 20,920 piglets.

For assessing the effect of the composition of the instant invention on piglet PWM, the sows and their litters were randomly allocated to one of two study groups, either control or supplemented with the composition. From days 2 to 8 of age (farrowing day being considered day 1), Px piglets received once daily in an open piglet feeding pan 500 mL of an embodiment of the present invention comprising an aqueous solution comprising 1.534% glucose monohydrate, 0.22% sodium chloride; 0.15% potassium chloride; 0.17% glycine; 0.186% citric acid monohydrate; 0.10% sodium dihydrogen phosphate; 0.05% xanthan gum; 0.05% hydrolyzed whey protein concentrate; 0.04% L-glutamic acid; 0.04% monosodium glutamate; and 0.01% Rebaudioside A. For some of the studies, the administration of the composition was continued beyond day 8, at the introduction of creep feed or for 3 days pre-weaning. The creep feed administration involved mixing 20 ml of the solution with 100 g of creep feed. When administered for 3 days pre-weaning, the composition (500 ml/litter/day) was poured into the creep feed at a 1:1 ratio. The quantity of creep feed offered per litter was in accordance with the farm husbandry practices of each farm that took part in the study.

For each of the studies, piglets were weighed at birth (or as close as possible after birth) and at weaning (˜20 days of age). Pre-weaning mortality was recorded for all piglets (with age and weight at death, and apparent cause of death, where possible). Information about the sow (parity, litter size, individual sow ID and litter weaning age) was also collected from each of the studies.

For the assessment of the effects of administration of the composition disclosed herein on PWM, mortality was analyzed using a logistic regression model using PROC GLIMMIX in the commercially available SAS software (SAS version 9.4, Cary, N.C., USA). To account for any differences of the production system and farm performance between the studies, the study ID was included as a random effect in the analysis. Sow ID was also included as a random effect in the analysis to account for a maternal effect on PWM. Both study ID and sow ID were statistically significant in this analysis (P<0.05).

Treatment, and the treatment×birth weight category interaction were included as fixed effects in the model. The slice option was used to test for treatment effects within each initial weight category.

To ensure that none of the treatment groups had any baseline advantages over the other, litter size was included as a covariate in the analysis. Parity and gender were not included as covariates in the analysis since this information was not available for all studies. However, the parity and gender distribution were not significantly different between treatments (P>0.05).

To assess the effect of weighing age on birth weight, the latter was analyzed separately using PROC MIXED in SAS, with age at weighing as a fixed effect and with Sow ID and study ID as random effects.

For all treatment comparisons, the litter was considered the experimental unit.

Differences were considered significant at P<0.05 and considered a near-significant trend at 0.05<P≤0.10.

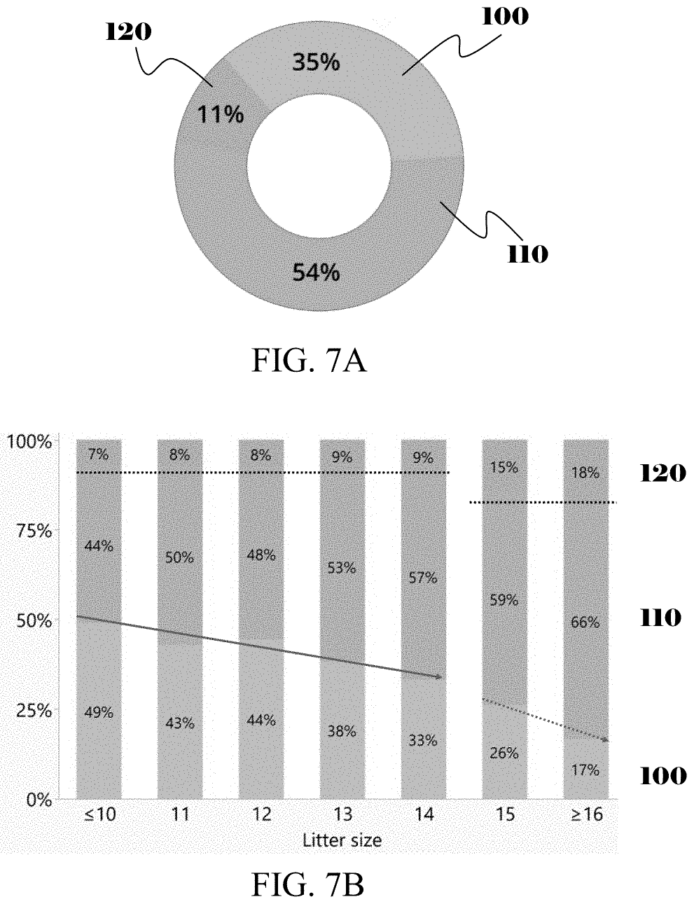

The overall birth weight distribution of piglet population of these studies comprised 35% H-pigs, 54% M-pigs, and 11% S-pigs. Reference is now made to FIG. 7A, which presents graphically the population distribution, with H-pigs indicated by reference number 100, M-pigs by reference number 110, and S-pigs by reference number 120. Reference is now made to FIG. 7B, which shows the birth weight distribution as a function of litter size (N=2330 litters).

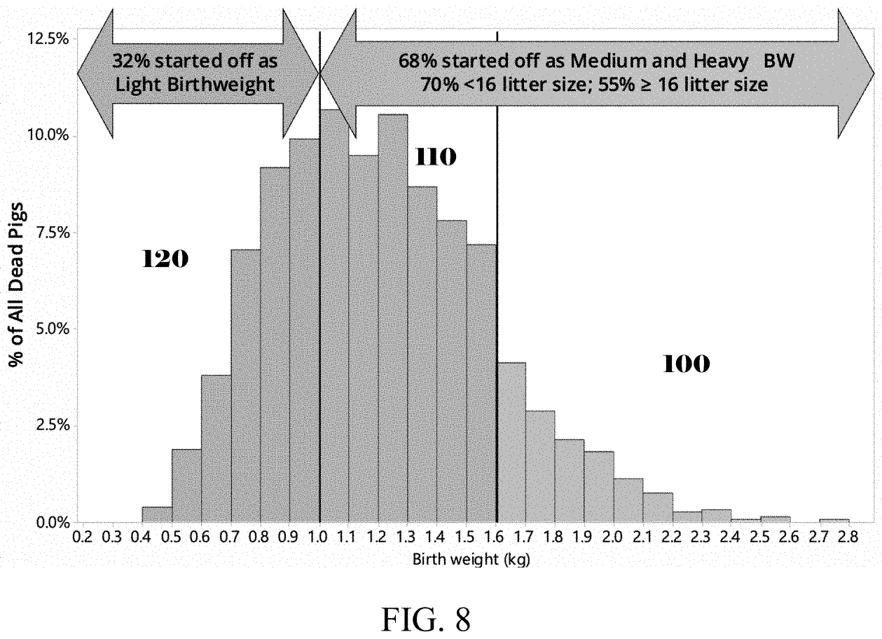

Reference is now made to FIG. 8, which presents graphically the distribution of the piglets in the study that died prior to weaning according to their birth weights. As shown in the graph, 68% of the piglets in the studies reported here that died prior to weaning were M- or H-pigs, while only 32% of the piglets that died prior to weaning were L-pigs.

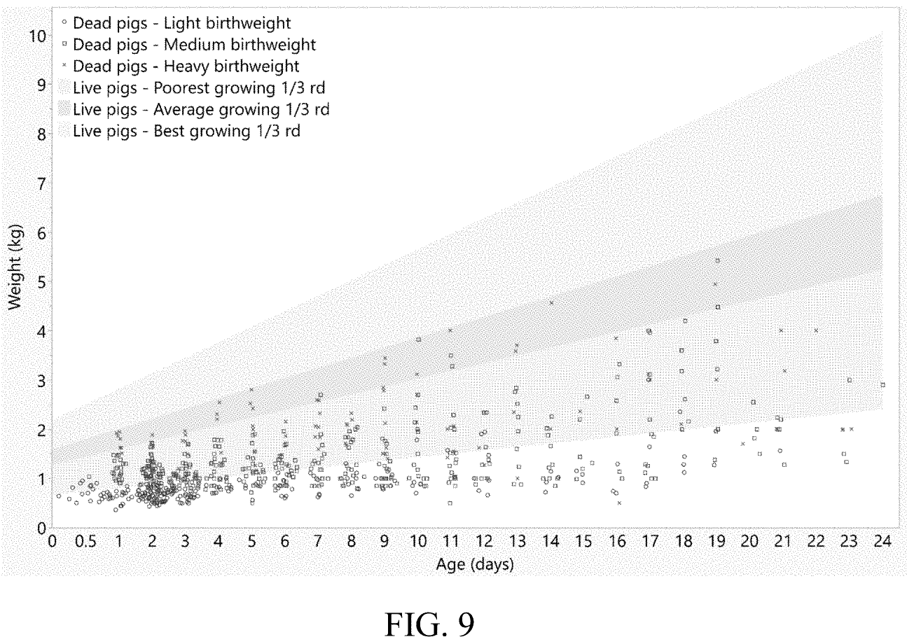

Reference is now made to FIG. 9, which presents graphically a comparison of the weights and ages of the piglets that died prior to weaning with the weights and ages of their live counterparts. The symbols in the graph indicate the ages and weights of the piglets that died prior to weaning, with the colors showing their birth weight category. The shaded areas indicated the weights of the pigs that lived and were weaned as a function of age, with the different shadings indicating the top, middle, and bottom thirds of the weight distribution, respectively.

As can clearly be seen in the figure, the body weights of the piglets that died prior to weaning were stunted in comparison to the body weights of their live counterparts; specifically, 91% of the pigs that died prior to weaning were in the bottom third of body weights when compared to their live counterparts of the same age. It is also clear from the figure, however, that PWM affects piglets of all birth weight categories.

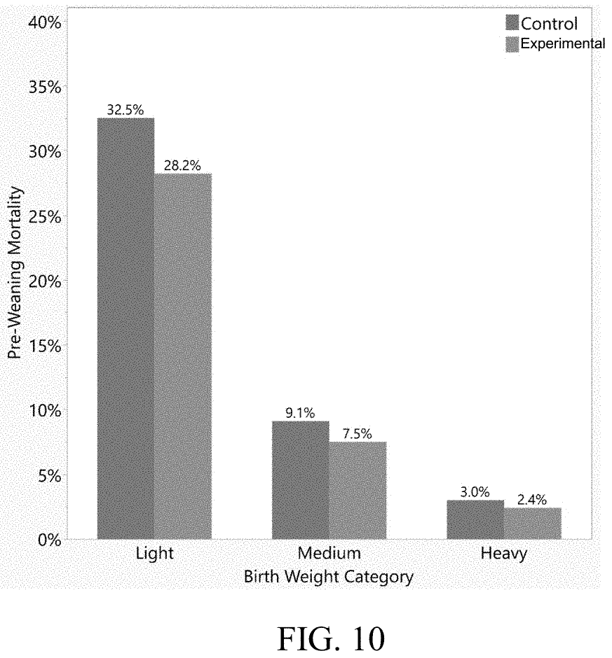

In a meta-analysis of the data presented in this example, it was determined that administration of the composition disclosed herein significantly reduced overall PWM by 17% (10.2% in the control group vs. 8.5% in the group provided with Px, p<0.01). The effect was uniform across all birth weight categories. For M-pigs, administration of the composition reduced PWM by 18%, from 9.1% to 7.5% (p=0.01). Albeit not reaching statistical significance, administration of the composition reduced PWM by 20% in H-pigs, from 3.0 to 2.4% (p=0.16) and in L-pigs by 13%, from 32.5% to 28.2% (p=0.11). Reference is now made to FIG. 10, which presents a graphical comparison of PWM by birthweight category for piglets provided with the composition disclosed herein with PWM by birthweight category for piglets in the control group. Thus, it can be seen that, surprisingly, providing piglets with the composition disclosed herein, in particular, embodiments of the invention in which the glycine concentration is less than 0.2% w/v, reduces PWM by more than 15% regardless of the piglets' birth weight.

### Example 12

### Administration of the Instant Composition to Post-Weaning Piglets—a Meta-Analysis

A set of trials was performed in seven different farms in the U.S.A., involving a total of 31,861 post-weaning piglets, ranging from 848 to 8,070 pigs per trial. The piglets were weaned from day 16 to day 23 (average weaning age 18.5 days), and the travel time to the farm was between 3 and 15 hours.

The piglets were divided into two groups, a control group that was provided with plain water, and an experimental group that was provided with an embodiment of the instant invention in which the composition was a powder comprising 25.25% anhydrous glucose, 25.2% sucrose, 20% monosodium glutamate, 3% anhydrous citric acid, 5% hydrolysed whey protein concentrate, 5% glycine, 5% sodium chloride, 2.5% potassium chloride, 2% oligofructose, 1.5% sodium saccharin, 1.25% rebaudioside A, 0.5% trisodium citrate, 0.5% sodium benzoate, and 3.3% of a component selected from the group consisting of spray dried beetroot powder, spray dried carrot powder, dehydrated beet juice, and dehydrated carrot juice. An aqueous solution of an 0.2% (w/v) of the powder was provided through the regular water lines for five days according to a protocol in which a solution of the powder disclosed above (0.2% w/v) was provided on the first day, a half-dose (i.e. a solution of the powder diluted to 0.1% w/v) was provided on the second and third days, and a quarter-dose (i.e. a solution of the powder diluted to 0.05% w/v) on the fourth and fifth days. The water consumption of the piglets provided with the composition during the five days in which it was provided was measured in comparison to the water consumption of a control group of piglets that were provided with plain water. The results are summarized in Table 12.

TABLE 12

| | Water intake, L/pig | | |
|---|---|---|---|
| Day | control | instant invention | p value |
| 1 | 0.37 | 0.78 | 0.02 |
| 2 | 0.37 | 0.77 | 0.01 |
| 3 | 0.46 | 0.83 | 0.02 |
| 4 | 0.55 | 0.77 | 0.07 |
| 5 | 0.53 | 0.77 | 0.05 |
| Daily average | 0.46 | 0.78 | 0.002 |

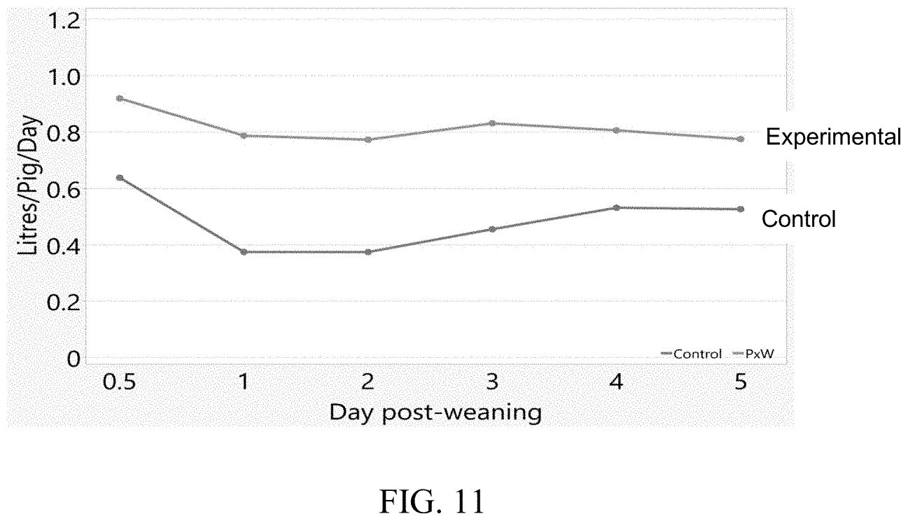

Reference is now made to FIG. 11, which presents graphically the results summarized in Table 12. The piglets provided with the composition of the instant invention drank, on average, 1.7 times more water per day than the piglets in the control group that were provided with plain water. On the first two days following the transport of the piglets to the nursery, the piglets provided with the composition of the instant invention drank more than twice as much water on average than the piglets in the control group.

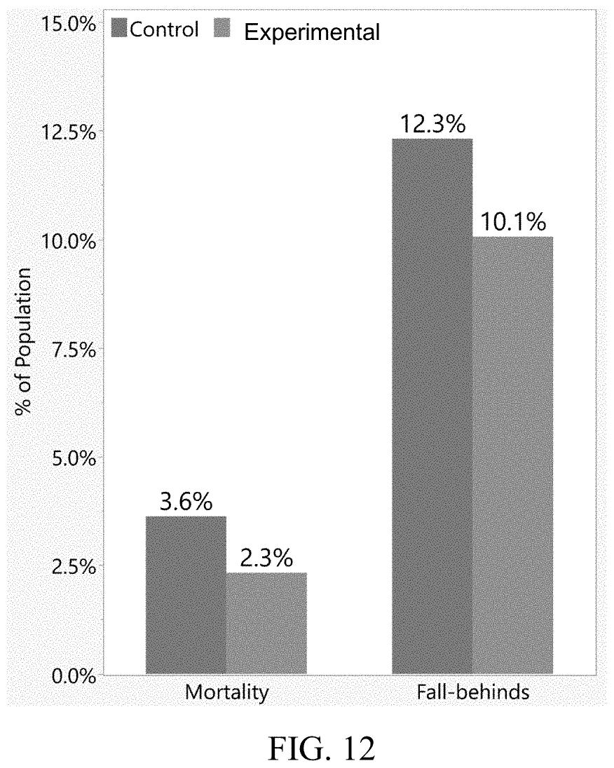

In addition to the relative water consumption, the piglet mortality and number of “fall-behinds” (weak piglets that were moved to hospital pens) over the three weeks following transport to the nursery were measured in the control and experimental groups. Mortality data were obtained for three farms (15,286 piglets total) and fall-behind data for four farms (17,070 piglets total). Compared to the control group, the piglets provided with the composition of the instant invention had 36% lower mortality (2.3% vs 3.6%; p<0.0001), and 18% fewer fall-behinds (10.1% vs 12.3%; p<0.0001). In trials performed in farms with no active disease, mortality data was obtained for a total sample size of 7,514 piglets and fall-behind data for a total sample size of 9,298 piglets. In these trials, the experimental group showed a 57% reduction in mortality relative to the control group (0.7% in the control group vs. 0.3% in the experimental group, p=0.01) and a 41% reduction in the number of fall-behinds (4.4% in the control group vs. 2.6% in the experimental group, p<0.001). In a trial conducted on a farm with an active PRRS outbreak (7,772 pigs total), there was a 34% reduction in mortality (6.5% in the control group vs. 4.3% in the experimental group, p<0.0001) and a 13% reduction in the number of fall-behinds (21.8% in the control group vs. 18.9% in the experimental group, p<0.0001). These results translate to four fewer deaths and 18 fewer fall-behinds for every 1000 pigs weaned on farms with no active disease, and 22 fewer deaths and 29 fewer fall-behinds for every 1000 pigs weaned on farms with active PRRS outbreaks. Reference is now made to FIG. 12, which presents a graph comparing mortality and fall-behind rates in the experimental group of piglets that were provided with the composition disclosed herein with mortality and fall-behind rates in the control group.

The results of the foregoing meta-analysis clearly demonstrate that use of the instant invention effectively and significantly increases water intake in post-weaning piglets while effectively and significantly reducing mortality and the number of fall-behinds.

1. An oral formulation for providing hydration to a mammal, said formulation in the form of a dry mix comprising glycine and at least two components selected from the group consisting of steviol glycoside, citric acid monohydrate, glutamic acid, and monosodium glutamate, wherein said dry mix is characterized by a glycine concentration of 5-6% (w/w).

2. The oral formulation according to claim 1, wherein said oral formulation is an aqueous solution of said dry mix, said aqueous solution characterized by a glycine concentration of 0.001-0.2% (w/v).

3. The oral formulation according to claim 1, wherein said oral formulation is an aqueous solution of said dry mix, said aqueous solution comprising 0.1-7 g dry mix/100 ml solution.

4. The oral formulation according to claim 1, wherein said oral formulation is in the form of an edible gel.

5. The oral formulation according to claim 1, wherein said oral formulation additionally comprises a prebiotic selected from the group consisting of oligosaccharides and fructo-oligosaccharides.

6. The oral formulation according to claim 1, wherein said formulation additionally comprises at least one component selected from the group consisting of probiotics, vaccines, iron-containing compositions, minerals, salts, amino acids, medicaments, vitamins, nutraceuticals, and taste enhancers.

7. The oral formulation according to claim 1, wherein said oral formulation is selected from the group consisting of:
a dry mix comprising about 55.800% anhydrous glucose; about 7.334% sodium chloride; about 5.000% about potassium chloride; about 5.000% glycine; about 1.667% xanthan gum; about 3.333% monosodium phosphate; about 2.000% anhydrous citric acid; about 5.000% hydrolyzed whey protein isolate; about 1.333% L-glutamic acid; about 13.000% monosodium glutamate; about 0.333% Rebaudioside A (98% min.); about 0.100% thaumatin; and about 0.003% apple flavor;
a powder comprising about 52.00% anhydrous glucose; about 6.286% sodium chloride; about 4.286% potassium chloride; about 4.286% glycine; about 2.856% monosodium phosphate; about 6.286% anhydrous citric acid; about 14.286% spray-dried liver hydrolysate; about 2.857% oligosaccharide; about 1.143% L-glutamic acid; about 5.428% monosodium glutamate; and about 0.286% Rebaudioside A (98% min.); and,
a powder comprising about 33.50% anhydrous glucose; about 5.00% sodium chloride; about 3.75% potassium chloride; about 7.50% glycine; about 2.50% monosodium phosphate; about 7.50% anhydrous citric acid; about 25.00% spray-dried liver hydrolysate; about 2.50% fructo-oligosaccharide; about 1.00% L-glutamic acid; about 4.75% monosodium glutamate; about 2.00% taurine; and about 5.00% powdered roast chicken flavor.

8. The oral formulation according to claim 2, wherein said oral formulation is selected from the group consisting of:
a solution comprising about 1.674% anhydrous glucose; about 0.220% sodium chloride; about 0.150% potassium chloride; about 0.150% glycine; about 0.050% xanthan gum; about 0.100% monosodium phosphate; about 0.060% anhydrous citric acid; about 0.150% hydrolyzed whey protein isolate; about 0.040% L-glutamic acid; about 0.390% monosodium glutamate; about 0.010% Rebaudioside A (98% min.); about 0.003% thaumatin; about 0.003% apple flavor; and the balance water;
a solution comprising about 1.60% anhydrous glucose; about 0.22% sodium chloride; about 0.15% potassium chloride; about 0.15% glycine; about 0.20% xanthan gum; about 0.10% monosodium phosphate; about 2.00% liquid liver hydrolysate; about 0.10% oligosaccharide; about 0.04% L-glutamic acid; about 0.19% monosodium glutamate; about 0.20% burnt sugar; about 0.01% Rebaudioside A (98% min.); and the balance water;
a solution comprising about 1.60% anhydrous glucose; about 0.22% sodium chloride; about 0.15% potassium chloride; about 0.15% glycine; about 0.40% xanthan gum; about 0.10% monosodium phosphate; about 2.00% liquid liver hydrolysate; about 0.10% oligosaccharide; about 0.04% L-glutamic acid; about 0.19% monosodium glutamate; about 0.20% burnt sugar; about 0.01% Rebaudioside A (98% min.); and the balance water;
a solution comprising about 1.60% anhydrous glucose; about 0.22% sodium chloride; about 0.15% potassium chloride; about 0.15% glycine; about 0.12% xanthan gum; about 0.10% monosodium phosphate; about 2.00% liquid liver hydrolysate; about 0.10% oligosaccharide; about 0.04% L-glutamic acid; about 0.19% monosodium glutamate; about 0.20% burnt sugar; about 0.01% Rebaudioside A (98% min.); and the balance water;
a solution comprising about 1.82% anhydrous glucose; about 0.22% sodium chloride; about 0.15% potassium chloride; about 0.15% glycine; about 0.10% monosodium phosphate; about 0.22% anhydrous citric acid; about 0.50% spray-dried liver hydrolysate; about 0.10% oligosaccharide; about 0.04% L-glutamic acid; about 0.19% monosodium glutamate; about 0.01% Rebaudioside A (98% min.); and the balance water; and,
a solution comprising about 1.45% glucose monohydrate, about 0.2% sodium chloride; about 0.15% potassium chloride; about 0.15% glycine; about 0.04% sodium dihydrogen phosphate; about 0.4% trisodium citrate; about 0.1% monosodium glutamate; about 0.01% Rebaudioside A (98% min.); about 0.1% fructo-oligosaccharide; about 4% liquid liver hydrolysate; about 0.4% burnt sugar; about 0.05% phosphoric acid; and the balance water.

9. The oral composition according to claim 4, wherein said composition is in the form of a gel comprising about 1.69% anhydrous glucose; about 0.22% sodium chloride; 0.15% potassium chloride; about 0.15% glycine; about 0.60% of at least one substance selected from the group consisting of kappa carrageenan gum, agar, and pectin; about 0.60% locust bean gum; about 0.20% xanthan gum; about 0.10% oligosaccharide; about 0.50% spray-dried chicken liver; about 0.04% L-glutamic acid; about 0.19% monosodium glutamate; about 0.10% burnt sugar syrup; about 0.01% Rebaudioside A (min 98%); and the balance water.

10. A method for the hydration of a mammal, said method comprising administering orally to said mammal an effective dose of a formulation, said formulation comprising glycine and at least two components selected from the group consisting of steviol glycoside, citric acid monohydrate, glutamic acid, monosodium glutamate, wherein said formulation is in a form selected from an edible dry mix characterized by a glycine concentration of 5-6% (w/v); an aqueous solution characterized by a glycine concentration of 0.001-0.2% (w/v); and an edible gel characterized by a glycine concentration of 0.001-0.2% (w/v).

11. The method according to claim 10, wherein said formulation additionally comprises a prebiotic selected from the group consisting of oligosaccharides and fructo-oligosaccharides.

12. The method according to claim 10, wherein said formulation additionally comprises at least one component selected from the group consisting of probiotics, vaccines, iron-containing compositions, minerals, salts, amino acids, medicaments, vitamins, taste enhancers, and nutraceuticals.

13. The method according to claim 10, wherein said formulation is an aqueous solution of said dry mix, said aqueous solution comprising 0.1-7 g dry mix/100 ml solution.

14. The method according to claim 10, wherein said step of administering comprises administering after said mammal has undergone physical activity.

15. The method according to claim 10, wherein said mammal is a horse, and said formulation is selected from the group consisting of:
a solution comprising 97.000% demineralized water; 1.674% anhydrous glucose; 0.220% sodium chloride; 0.150% potassium chloride; 0.150% glycine; 0.050% xanthan gum; 0.100% monosodium phosphate; 0.060% anhydrous citric acid; 0.150% hydrolyzed whey protein isolate; 0.040% L-glutamic acid; 0.390% monosodium glutamate; 0.010% Rebaudioside A (98% min.); 0.003% thaumatin; and 0.003% apple flavor; and,
a dry mix comprising about 55.800% anhydrous glucose; about 7.334% sodium chloride; about 5.000% potassium chloride; about 5.000% glycine; about 1.667% xanthan gum; about 3.333% monosodium phosphate; about 2.000% anhydrous citric acid; about 5.000% hydrolyzed whey protein isolate; about 1.333% L-glutamic acid; about 13.000% monosodium glutamate; about 0.333% Rebaudioside A (98% min.); about 0.100% thaumatin; and about 0.003% apple flavor.

16. The method according to claim 10, wherein said mammal is a dog, and said formulation is selected from the group consisting of:
a solution comprising about 1.60% anhydrous glucose; about 0.22% sodium chloride; about 0.15% potassium chloride; about 0.15% glycine; about 0.20% xanthan gum; about 0.10% monosodium phosphate; about 2.00% liquid liver hydrolysate; about 0.10% oligosaccharide; about 0.04% L-glutamic acid; about 0.19% monosodium glutamate; about 0.20% burnt sugar; about 0.01% Rebaudioside A (98% min.); and the balance demineralized water;
a solution comprising about 1.60% anhydrous glucose; about 0.22% sodium chloride; about 0.15% potassium chloride; about 0.15% glycine; about 0.40% xanthan gum; about 0.10% monosodium phosphate; about 2.00% liquid liver hydrolysate; about 0.10% oligosaccharide; about 0.04% L-glutamic acid; about 0.19% monosodium glutamate; about 0.20% burnt sugar; 0.01% Rebaudioside A (98% min.); and the balance demineralized water;
a solution comprising about 1.60% anhydrous glucose; about 0.22% sodium chloride; about 0.15% potassium chloride; about 0.15% glycine; about 0.12% xanthan gum; about 0.10% monosodium phosphate; about 2.00% liquid liver hydrolysate; about 0.10% oligosaccharide; about 0.04% L-glutamic acid; about 0.19% monosodium glutamate; about 0.20% burnt sugar; about 0.01% Rebaudioside A (98% min.); and the balance demineralized water;
a solution comprising about 1.82% anhydrous glucose; about 0.22% sodium chloride; about 0.15% potassium chloride; about 0.15% glycine; about 0.10% monosodium phosphate; about 0.22% anhydrous citric acid; about 0.50% spray-dried liver hydrolysate; about 0.10% oligosaccharide; about 0.04% L-glutamic acid; about 0.19% monosodium glutamate; about 0.01% Rebaudioside A (98% min.); and the balance water;
a powder comprising about 52.00% anhydrous glucose; about 6.286% sodium chloride; about 4.286% potassium chloride; about 4.286% glycine; about 2.856% monosodium phosphate; about 6.286% anhydrous citric acid; about 14.286% spray-dried liver hydrolysate; about 2.857% oligosaccharide; about 1.143% L-glutamic acid; about 5.428% monosodium glutamate; and about 0.286% Rebaudioside A (98% min.); and,
a gel comprising about 1.69% anhydrous glucose; about 0.22% sodium chloride; about 0.15% potassium chloride; about 0.15% glycine; about 0.60% of at least one substance selected from the group consisting of kappa carrageenan gum, agar, and pectin; about 0.60% locust bean gum; about 0.20% xanthan gum; about 0.10% oligosaccharide; about 0.50% spray-dried chicken liver; about 0.04% L-glutamic acid; about 0.19% monosodium glutamate; about 0.10% burnt sugar syrup; about 0.0.1% Rebaudioside A (min. 98%); and the balance water.

17. A method of producing a formulation for inducing a mammal to increase its water intake, wherein said method comprises mixing a meat or chicken hydrolysate, meat or chicken flavorings, water, at least one sweetener, at least one prebiotic, glycine, and at least three components selected from the group consisting of steviol glycoside, citric acid monohydrate, glutamic acid, monosodium glutamate, wherein said method comprises mixing a quantity of glycine to yield a final glycine concentration of 5-6% (w/v).

18. The method according to claim 17, additionally comprising adding at least one component selected from the group consisting of probiotics, vaccines, iron-containing compositions, minerals, salts, amino acids, medicaments, vitamins, taste enhancers, and nutraceuticals.

19. The method according to claim 17, further comprising producing an aqueous solution comprising 0.1-7% (w/v) of said dry mix.

20. The method according to claim 17, further comprising diluting said formulation in sufficient water to produce an aqueous solution characterized by a glycine concentration of 0.001-0.2% (w/v).
